(19) United States
(12) Patent Application Publication
(10) Pub. No.: US 2015/0365725 A1
(43) Pub. Date: Dec. 17, 2015

(54) EXTRACT PARTITION SEGMENTS OF PERSONALIZED VIDEO CHANNEL

(71) Applicant: Rawllin International Inc., Tortola (VG)

(72) Inventors: Leonid Belyaev, Moscow (RU); Igor Sokolov, Saint-Petersburg (RU); Ilya Baronshin, Moscow (RU)

(21) Appl. No.: 14/302,374

(22) Filed: Jun. 11, 2014

(51) Int. Cl. H04N 21/458; H04N 21/472; H04N 21/466; H04N 21/462; H04N 21/45; H04N 21/854; H04N 21/439; H04N 21/61; H04N 21/482; H04N 21/4627

(52) U.S. Cl. CPC H04N 21/458; H04N 21/4826; H04N 21/47214; H04N 21/4668; H04N 21/4627; H04N 21/4532; H04N 21/854; H04N 21/439; H04N 21/6175; H04N 21/4622

(57) ABSTRACT

Video content from different media sources can be configured to be rendered via a personalized channel based on portions of video content being identified according to different topics. User profile data is generated with user preferences that can include one or more topics for portions of video content. Boundaries of the video content are tagged in response to transitions within the video content being recognized. The video content topics are stored with tags having metadata related to the portions of video content and indexed. The video content and media sources can be rendered to one or more mobile devices at different times with different content and/or at the same time based on user profile data and the indexed tags. The video content is communicated via the personalized video channel based on the topics and the user profile data.

### TECHNICAL FIELD

The subject application relates to video content, and, in particular, to personalizing and aggregating video content from media sources.

### BACKGROUND

Media content can consist of various forms of media and the contents that make up the different forms of media. For example, a film, video, movie or motion picture can comprise a series of still or moving images that are rapidly put together and projected onto/from a display. The video is produced by recording photographic images with cameras, or by creating images using animation techniques or visual effects. The process of filmmaking has developed into an art form and a large industry, which continues to provide entertainment to masses of people, especially during times of war or calamity.

Typical television or video programming provides a set programming schedule combining pre-set programming that is sequentially broadcast to a user via a particular channel. The user establishes what television programming, channel and the corresponding times that the programs are being broadcasted. The user is then able to select from among a set number of broadcast channels, programming and/or times for the video to choose from. As a result, the user relies on the taste of the broadcasting studio to provide interesting content, at available times and on available channels for viewing. If the content is not suitable, another broadcast channel is selected or the user can opt to find different television entertainment, such as a movie rental, paid programming, online streaming, and/or rely upon recording devices to store the video on a particular channel for later viewing. The above trends or deficiencies are merely intended to provide an overview of some conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and communicating media content and/or media content portions corresponding to various media sources via a personalized video channel are described herein. An exemplary system comprises a memory that stores computer-executable components and a processor, communicatively coupled to the memory, which is configured to facilitate execution of the computer-executable components. The computer-executable components comprise a source component that is configured to identify video content and a plurality of media sources comprising at least one of a web data feed, a wireless broadcast media channel, a web site, and a wired broadcast channel for communication via a personalized video channel. A data analysis component configured to analyze the video content and corresponding audio content to identify a plurality of topics of the plurality of media sources. A portioning component configured to portion the video content into portions from the plurality of media sources based on the plurality of topics. A profile component configured to generate user profile data based on a set of user preferences comprising a topic of the plurality of topics related to the video content. A streaming component configured to communicate the video content from the plurality of media sources to a display component based on the user profile data.

In yet another non-limiting embodiment, an exemplary method comprises identifying, by a system comprising at least one processor, a video content from media sources that comprise at least two of a broadcast media channel, a web page, a web data feed, a network subscription service or a video library for communicating the video content via a personalized video channel. The video content and audio content of the media sources are analyzed to determine a plurality of topics based on a set of predetermined criteria. The video content is portioned into portions of the video content corresponding to the plurality of topics. The portions from different media sources of the media sources are streamed at different times based on a set of user preferences comprising the plurality of topics via the personalized video channel.

In still another non-limiting embodiment, an exemplary computer readable storage medium is configured to store computer executable instructions that, in response to execution, cause a computing system including at least one processor to perform operations. The operations comprise identifying a video content from media sources for streaming via a personalized video channel. The operations comprise analyzing the video content and associated audio content of the video content from the media sources to determine a topic based on a set of predetermined criteria. The video content is portioned into portions corresponding to the topic. The portions of the video content are streamed from the media sources that comprise the topic via the personalized video channel.

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates another example system in accordance with various aspects described herein;

FIG. 5 illustrates another example system in accordance with various aspects described herein;

FIG. 6 illustrates another example system in accordance with various aspects described herein;

FIG. 7 illustrates another example system in accordance with various aspects described;

FIG. 8 illustrates an example of a flow diagram showing an exemplary non-limiting implementation for a system in accordance with various aspects described herein;

FIG. 9 illustrates another example of a flow diagram showing an exemplary non-limiting implementation for a system in accordance with various aspects described herein;

FIG. 10 illustrates another example of a flow diagram showing an exemplary non-limiting implementation for a system in accordance with various aspects described herein;

FIG. 11 illustrates another example of a flow diagram showing an exemplary non-limiting implementation for a system in accordance with various aspects described herein;

FIG. 12 illustrates another example of a flow diagram showing an exemplary non-limiting implementation for a system in accordance with various aspects described herein;

FIG. 13 illustrates another example of a flow diagram showing an exemplary non-limiting implementation for a system in accordance with various aspects described herein;

FIG. 14 illustrates another example of a flow diagram showing an exemplary non-limiting implementation for a system in accordance with various aspects described herein;

FIG. 15 illustrates another example of a flow diagram showing an exemplary non-limiting implementation for a system in accordance with various aspects described herein;

FIG. 16 is a block diagram representing exemplary non-limiting networked environments in which various non-limiting embodiments described herein can be implemented; and

FIG. 17 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. The word “set” is also intended to mean “one or more.”

### Overview

In consideration of the above-described trends or deficiencies among other things, various embodiments are provided that aggregate video content into a single personalized communication channel and/or into multiple personalized channels, which are configured independently according to portions of video content. The portions of video content can be extracted from different media sources, portions of segments or subsets of video content (e.g., programming from broadcast media sources, video uploads on a network, web data feeds—RSS feeds, and the like), and/or tags corresponding to the portions of the video content that are indexed. The video content portions can be identified via information provided or generated as user profile data, which can include a user's likes and dislikes for timing, content and/or source of content, as well as keywords/topics banned or liked by the user. The system operates to personally configure personal channels independently according to a user profile data that comprises user preferences and/or tracked behavioral data corresponding to the respective channels, as well as predicted video content and respective media sources.

In one embodiment, transitions within video content from identified media sources are detected based on characteristics of the video content and/or audio content that indicate boundaries, such as boundaries between topics or subject matter. Video content and portions of the video content that are similar in topic can be compared to determine differences. The video content portions that are compared can be from different media sources, from the same media sources with different dates, time slots and/or time stamps associated with the video content, and/or from different videos. Video content portions that rank higher in quality, video characteristics and/or in correlation to the user profile data can be presented to the user as a video content option, while other video content portions can be discarded or set for scheduling via the personalized video channel at a later time.

For example, a set of predetermined criteria can be used to recognize transitions or boundaries for topic analysis to generated indexed tags associated with portions of video content. Portions can include subsets of segments of video from a media source, or segments within scheduled or a defined programming, such as a news broadcast, a new hour or a news program that has multiple topic/subject segments within. The portions can be recalled from an index map and generated at another time for viewing via the personalized video channel from the media source. The predetermined criteria can include characteristics related to the physical attributes of video (e.g., bitrate, resolution, signal to noise ratio, color attributes, etc.), metadata associated with the video content, media source programming or external programming guides providing information about the video content, categories or classification data about the video content, audio analysis data (e.g., voice recognition, word/phrase translation, audio to text translation, etc.), comparison data between video content, and other sources of data that can be used to analyze the video content as criteria for detecting transitional boundaries and associated topics.

For example, a personalized video channel can be dynamically configured according to the user profile data, and updated user profile data as it is learned by the system with particular topics of interest to a user. The system allows a user to re-configure or personalize a channel as well as have multiple configured channels that are each set according to different preferences and/or user profile data. As video content changes and becomes available from a media source (e.g., with updated programming, newly added family videos, recently released video rentals, recently aired programming, current news broadcast, and the like) video content options for viewing content from various media sources can become updated for the personalized channel.

In various other embodiments described herein, video content is analyzed from different media sources as the media sources become identified, and then topics discussed or portrayed in segments or portions of the content are identified by identifying transitions/boundaries based on predetermined criteria including frame differences, matching audio content with the topic or topic preference, variations within scenes or settings of frames, changes in performers, viewing settings such as color, contrast, and the like. The transitions can be indexed and the video content, as well as portions or subsets of portions of video can be updated dynamically for any given scheduled time of viewing via a particular personalized channel. The indexed tags for portions of the video content can then be used to configured the personalized video channel with video content segments or portions from different media sources for viewing consecutively, a the same time in different windows or view panes, and/or in predetermined time slots or dates.

User profile data can be further utilized to determine what topics to search for among video content and portions of video content, the topics that are of interest to the user, and the criteria should be used for providing video content from various media sources. The user profile data can include preferences, classification criteria, and behavioral data that represents user control inputs related to video content (e.g., search term(s), a video purchase, a video upload/download, a video viewed, a website video viewed, a subscription service add, a stored syndicated feed identifier, and/or the like). A user of the systems herein can configure various channels to stream content from various media sources according to portions of segments based on a different sets of preferences that include particular topics in a user profile to one or more mobile devices differently and/or at the same time along with different media content for interaction with the content and sources and/or with other mobile/display components that the personalized channel is shared/subscribed with. The user profile can comprise a user's preferences for view time, communicated content or programming, a media source, a personalized data store, and/or other real time feed that can be communicated via the personalized channel at a set time or dynamically as viewing options being promoted or updated from other candidate media sources (e.g., broadcasting channels, Facebook news feed, and/or an Rich Site Summary feed or the like). The personalized video channel can be configured by one personal device with a set of profile data corresponding to the channel and can be shared or published with multiple friends and/or authorized subscribers.

For example, a user can enter a voice command or other command for a particular topic, in which the topic can then be searched among various portions already indexed or initiate indexing of video content/portions/segments based on recently or updated video content/media sources/user profile data. The personalized video channel can be configured for or by the user based on the command stored in the user profile data by the authenticated/primary user associated with the user profile data. For example, the topic could be for viewing a news story on a recent event such as a weather event or local tragedy, for example. In response to the user profile data receiving a particular topic, video content, portions of video content and/or portions of subsets of video content can be searched for among media sources. In addition or alternatively, the video content can be analyzed and tagged for various topics without having any particular topic that is searched for. Tags and metadata associated with the video content, the portions of video content and/or portions of subsets of the video content. The various topics can be presented to a user to schedule for viewing at various times and/or sequential orders for viewing via the personalized video channel. The video content from the media sources can be provided according to the indexed tags and retrieved for the video content, portions and/or portions of subsets to be streamed from the media sources at predetermined scheduled times. Various other embodiments, details and components are further described with reference to the illustrated figures below.

### Extract Partition Segments of Personalized Video Channel

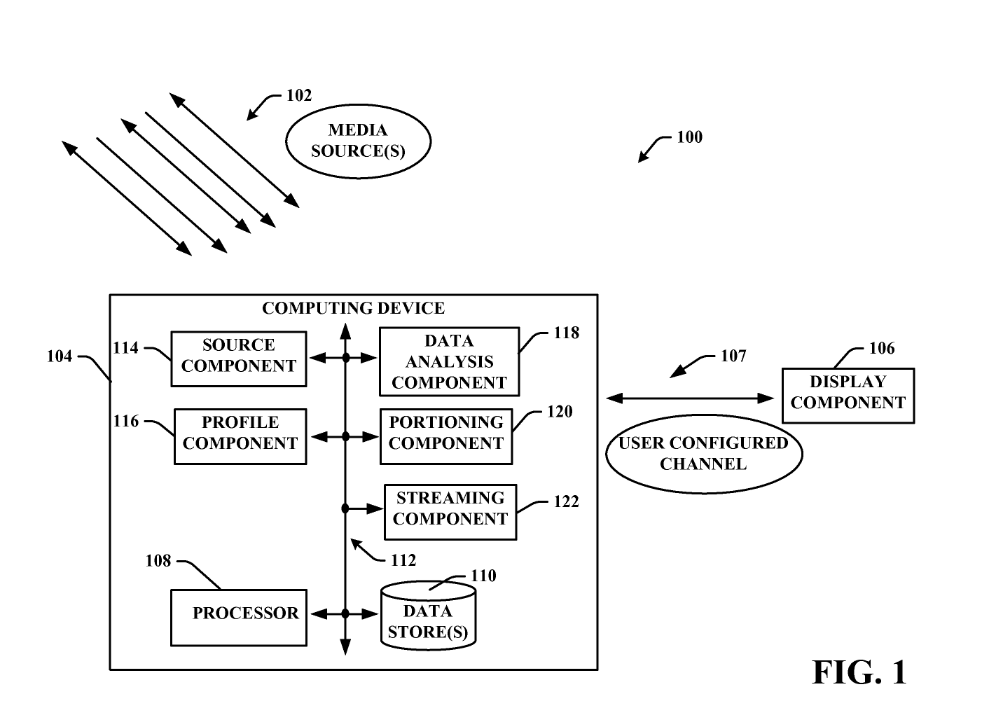

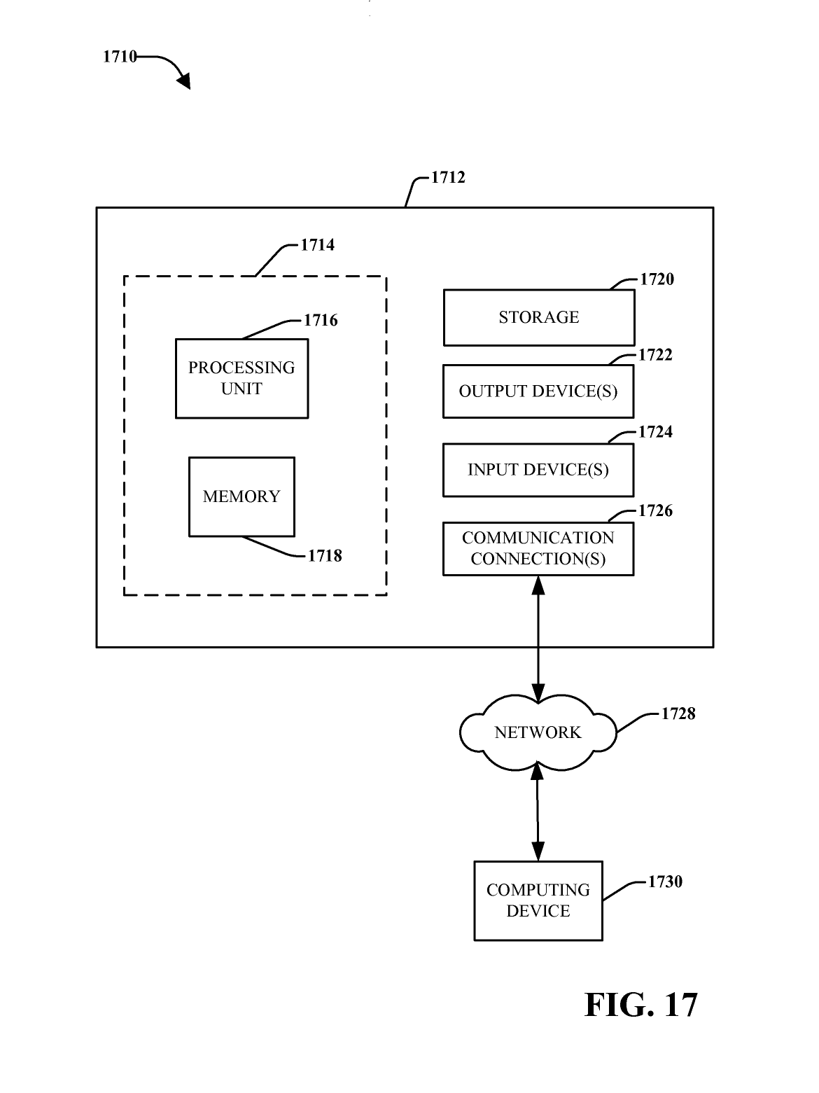

Referring to FIG. 1, illustrated is an example system 100 that generates a user configured video channel based on a user profile in accordance with various embodiments disclosed. System 100 can include a memory or data store(s) 110 that stores computer executable components and a processor 108 that executes computer executable components stored in the data store(s), examples of which can also be found with reference to other figures disclosed herein and throughout, such as the computer device 1712 of FIG. 17 and in other figures of this disclosure. The system 100, for example, includes a computing device 104 that can include a mobile device, a smart phone, a laptop, personal digital assistant, personal computer, mobile phone, a hand held device, digital assistant and/or other similar device, which can include hardware and/or software communicating via a network, a wireless and/or wired transmission.

The computing device 104 operates to receive and aggregate multiple media sources 102 and corresponding content (e.g., news broadcast, television programming, web cast, web page feeds, personal data and other media content) into a single communication channel 107 to be rendered in a display component 106 for viewing by the user implementing the channel configurations and also by friends of other mobile devices that can interact for a community experience at scheduled broadcast times. The computing device 104 comprises various components that can operate and/or communicate via a network as the user configured video channel 107, wired and/or wireless communication channels, and the like. The computing device 104 comprises a source component 114, a profile component 116, a data analysis component 118, a portioning component 120 and a streaming component 122 that are communicatively coupled via a communication line 112 (e.g., an optical link, a bus, a wireless connection, etc.) to obtain media content (e.g., video content) from various media sources, aggregate the media content via the processor 108 and data store(s) 110 and dynamically communicate the media content in response to user profile data via a single personalized video channel 107.

The source component 114 is configured to obtain video content from a set of media sources. The source component 114 operates, for example, to identify video content from a plurality of media sources comprising a wireless broadcast media channel, a web page, a web feed (web data feed), and/or a wired broadcast for communication via the personalized video channel 107, examples of which can include social network feeds, programming feeds, news feeds, local channel digital/analog broadcasting over air, cable broadcasting, internet content, video rental/subscription services on the internet, and the like. The source component 114 can be hardware (e.g., a processor), and/or software that searches networked communications, wireless communications via an antennae receiver/transceiver device, wired communications (e.g., optical, two-wire, etc.), local broadcasting, network web feeds, news feeds, web page content, data store(s), and the like. For example, the source component 114 is configured to dynamically identify broadcasted content from local broadcasting stations of locally aired programming, identify cable broadcast for paid/unpaid programming, TV-guide and/or other scheduling resources that publish scheduling or video content information as it is updated as metadata, a separate web page connection, and/or broadcast communication. The source component 114 further operates to identify and receive Rich Site Summary for new feeds of updated page content from social networks, channel pages, and/or subscribed services for video, as well as identify any other media source that communicates individual, studio produced, network uploaded, etc., video content for viewing at user defined preference times with user defined sources on a user controlled channel.

Various video content sources can be identified via the source component 114 utilizing a user profile (user profile data) generated by the profiling component 116. The profiling component 116 is configured to generate user profile data based on a set of user preferences related to the video content and/or a set of behavioral data. The user profile can include login information, a user name, authentication data, media source preferences, media content preferences, time preferences and/or other user preferences such as a title, subject genre and other classification criteria as discussed herein. The user preferences can include a time preference, for example, to associate with the media content or video content, a personalized channel selection, a theme preference for types of media content (e.g., Science Fiction, Drama, etc.), a rating preference (e.g., G rated films, five start films, etc.), an actor preference, a language preference (e.g., Spanish, Russian, English, etc.) and/or a date preference (e.g., release date, viewing dates, broadcast dates) pertaining to the personalized channel 107 for configuring identified media sources and content via the source component 114. The user profile data configured by the profiling component can further include classification criteria that include at least one of a theme, an age range, a media content rating, an actor or actress, a title, and the like metadata for identifying content, communicating media sources identified, and/or identifying updated media content of a media source and/or particular broadcast/upload/data store/feed stream.

In one embodiment, the user profile (data) generated by the profiling component 116 further comprises behavioral data that includes search data, viewing data, purchasing data, communicated data, each relating to ways the user of the user profile has interacted with video content as well as other user input controls related to video content (e.g., storage, viewing times, fast forwarding, skipping, replaying, search terms, and other input controls as related to video content). For example, if evidence of Minoan civilization in Northeast Michigan (5000 B.C.) is searched, the computing device 104 utilizes the components therein to define various videos related to this search data to establish media sources having similar or related content and provide configurable options to the user for generating a personalized dynamic channel for viewing on the display component 106 at various times that could correspond with a newly broadcast programming, purchased programming, rented programming, web updated programming, subscription service programming, recorded programming stored and/or the like.

For example, future viewing options can be communicated along with other metadata pertaining to the media content searched and the future viewing options can be programmed to view via the personalized channel 107 at the same time as the future scheduled viewing and/or stored for viewing at a another defined time. Therefore, a search engine (not shown) for video content of interest is coupled to the profiling component 116 in order to dynamically present scheduling options, broadcast options, and/or media content/source options for a user to configure the channel 107. The search engine can be any search engine of a network (e.g., internet network) and/or a search engine provided in a browser of the computing device and/or display component 106. The user can select to view, configure, purchase, subscribe and communicate any one of these content options on the channel 107 to a display component (not shown) of the system 100 as well as to other mobile subscribing friends to the user's configured channel. The criteria for presenting options to configure the channel 107 can be further limited based on user profile data that comprises the user preferences and/or behavioral data. Although a user is not intending to search for video content, the configurable personalized channel 107 and the computing device 104 operate in an operating background to ascertain user interest and user behavior along with set preferences to provide catered options for viewing when the user is ready to interact with video format or, in other words, operate television viewing for him/herself.

The behavioral data or user profile data can further include age data, household membership data and/or subscription data. The age data can comprise the age range of the user corresponding to the user profile, which can be used to ascertain a profile of age interest based on other population samples of similar age and/or generational preferences for dynamically interacting with the user for providing options to configure the personalized channel viewing experience. Household membership data can include other members of the user's household or immediate family, which can be used to configure other channels for their viewing as appropriate. The subscription data can be the various online or offline subscriptions that a user patronizes. For example, magazine subscriptions, cable subscriptions, video subscriptions (e.g., movie rental online or offline, such as internet subscriptions to streaming or by mail DVD content), video subscription sites, web feeds (e.g., social network news feeds), and the like can be identified and accessed as video content options and media sources for assigning to the channel 107 at defined times, for defined content, and the like. For example, if the user defined Friday night as watching one set of video content on the channel 107 from one media sources at a certain time, another video content from another media sources could be subsequently viewed automatically via the channel 107. The content can be set to be communicated via the channel 107 from various sources that offer different content. The content can be monitored for updated content, in which the user can be notified of and then select any number of options to configure the channel 107.

In addition, the behavioral data can include viewing information that rates a user's interest level in a video feed from one or more of the media sources. For example, the personalized viewing channel 107 can comprise a set of controls for operating the video content, in which the controls can be communicated to the display component 106. Based on the controls selected during viewing the computing device 104 can further ascertain user interest in the video content and make further recommendations of video content accordingly. For example, the controls can include directional controls, rewind, forward (to return to a previous segment or fast forward to a next one or a different program and/or a different media source), up and down (for changing different channels and/or different media sources, depending upon the personalized configuration of the channel).

The profiling component 116 further operates to aggregate profiles or log in access to a set of social networks, video subscription services online and/or other video distribution services and provides an access key for aggregating videos or media content via the source component 114. The user can connect his user profile to multiple services for video and provide the viewing over an assigned channel that is configured. Additionally, the profiling component 116 can import RSS subscriptions to the profile, in which the system 100 can operate to import video content, add video content, and updated content and information into the selected personalized channel 107.

The data analysis component 118 is configured to analyze video content and audio content to determine topics within portions or portions of subsets of the video content that are the predominate focus of the video content. The topics can be identified according to various criteria, such as a frequency of occurrence (detection) of a word or phrase from within the audio and/or video content from each media source 102, the mention of the main topic or focus, and/or the graphic portrayal or illustrations of a topic. For example, in response to a word or phrase frequency detection (e.g., a percentage or number of time mentions within respect to time) satisfying a predetermined threshold (e.g., an outlier of words compared to other word, a predetermined number and/or the like), a higher probability or a selection can be associated with the particular word or phrase as being a topic or a focus of the audio content and corresponding video content. The word or phrase can be identified by the system as being a topic for a timed duration of the video content, in which the timed duration can be at a cutoff in frequency (a predetermined threshold) and/or other transition criteria within the video content (e.g., scene settings change, detected vocal tone change as a predominate tone, view settings such as contrast, color, brightness, and/or other view settings for a display change, outlier determinations from other words within the same interval of time). Other indicators can also be analyzed, such as a verbal indication of the topic within video content, an illustration of the topic, a title or subtitle, as well as a graphical illustration of the topic.

For example, a video content can derive from a media source involving a news source with multiple different topics that could be covered within any one time duration, such as a CNN broadcast, podcast, RSS feed, etc. In some instances, a topic is displayed and identified by the system as a topic of being discussed, such as in a graphical illustration of a news flash headline, a sign, an overlay graphic bar, etc., in which the topic is weighted as more than likely being the flashed headline in addition with other criteria such as a frequency of detection for the word or phrase. In other instances, a news anchor could announce the topic, such as in a statement, “we now bring to you live weather in Kansas,” or continue to mention words, phrases that are being discussed, such as “weather,” “tornado” or “Kansas.” In addition, metadata can be ascertained from the upload, download, and/or link to an RSS feed that provides clues or data related to topic(s) of the video content from the media source, which can be analyzed from the video data itself and/or from external sources that independent of the media source, such as a channel guide or programming guide via a network.

The portioning component 120 is configured to portion the video content into portions from the plurality of media sources 102 based on the plurality of topics. The portioning component 120, for example, identifies areas, segments, and/or portions of subsets of the video content from the media sources 102. The identified portions (i.e., segments, segments/portions of subsets/portions/segments) can be extracted and stored as in partitions, as described further below, and/or tagged and indexed. In response to being tagged and indexed the associated tags can be recalled and utilized for streaming the portions at different times via the personalized video channel 107 from the media source. The video content thus does not need to be extracted in portions to save storage, but can be streamed from different media sources as different portions based on the indexed tags.

For example, there is a single file of an hour long show “60 seconds”, which consists of a half dozen plots. The system 100 operates to identify and extract each plot of the segment of video content. The system 100 can save each as a separate file with own metadata tags values describing content and to allow indexing, and/or generate an index map for the video content from particular media source and stream the content from the media source utilizing the tags saved separately. The division of a large video file into themed segments can be performed physically by cutting/splicing/partitioning a large file in smaller sub-files. Next, such sub-files files can be re-stored on the server of the video content operator/distributor data store.

Alternatively, large files can be analysed for start and end of each themed segment on the content owner servers, which can give content operator information of the segment topic with the start and end of each segment. That information can also be stored on the content operator servers (media source) and streamed from there via the personalized video channel 107. Thus there is no need to physically cut large file into sub files, plus, there is no need to allocate server space on the operator side, which saves money for hardware and maintenance.

For example, a user can find and request a news segment related to a particular event through the system 100 and the portioning component 120. The system 100 stores information about location on the remote servers of the requested file and timestamp for start and end of the requested segment. The system 100 can operate to play the segment from the timestamp and ends at the end of the segment at an ending timestamp. Thus, in addition to information of location of large video file and time start and end stamps of each segment, and segment description, the system 100 via the source component 114 and other components can regularly or periodically monitor video files and whether the video files are removed, and/or updated (changed). Thus, remote video segments from various media sources can be mapped to index files on own storage for easy retrieval and playback.

The computing device 104 can thus analyze video content from multiple different media sources, such as web data feeds (RSS feeds) and other media sources (e.g., a wireless broadcast media channel, a web site, a subscription service, network video service, and/or a wired broadcast channel), for example, for communication via the personalized video channel 107 based on user profile data. The data analysis component 118 operates to ascertain topics of video content and provide the topics as selection options for selection, scheduling, viewing, censoring, and/or sharing via the personalized video channel 107, while the portioning component 120 operates to control segments of the video content by identifying the portions according to predetermined criteria such as the user profile data, which can include classification criteria, user preferences, topic selection or topic key words, behavioral data and the like.

In response to media sources being identified and the portions of video content for a particular time slot or a defined time of a day, the data analysis component 118 can further operates to further analyze the media content for the particular preferences, settings, classifications, like and dislikes known and stored as the user profile data associated with a user. Various topics within the video content can be identified that are set as a preference by the user, in which the data analysis component 118 could search for among video content. Alternatively or additionally, topics of the video content can be identified without being listed as a user preference. Topics can be generated via the data analysis component 118 as selections to a user for viewing via the personalized video channel 107. The topics can be rendered as a list of topics, for example, that are identified within the video content and the identified/extracted portions of each media source for a particular time slot, time of day, date or time period, for example.

In one embodiment, the topics can be ranked and weighted for determining correlation measures to the user profile data so that most closely matched topics from higher rated or better quality video content are provided first on the list or in a top tier (e.g., a top 25% of selections). In another embodiment, topics and video content associated with the user profile data can further be provided in a list or rendered as a selection according to a classification, a topic, and/or other user preference that can be communicated to a user for scheduling viewing times via the personalized video channel. The selections communicated can be based on those video content selections satisfying a predetermined threshold, for example, a percentage or other weight associated with the video content ranking, which is further detailed below. The computer device 104 can then further operate to communicate the topics of the media content as selections for viewing via the personalized video channel 107 in response to scheduling by the user. As stated above, the user profile data can include user preferences and behavioral data that represent user input controls for the personalized video channel 107. The user preferences can comprise at least one of a media source preference, a time preference to associate with the video content for being communicated via the personalized video channel 107, a personalized channel selection from among multiple personalized video channels associated with one or more devices, a theme preference for the video content at particular times, a rating preference, an actor preference, a language preference, and/or a date preference, as well as a topic preference that sets a topic for searching, identification and/or viewing.

The streaming component 122 is configured to communicate the video content from the plurality of media sources 102 to the display component 106 (e.g., a display panel, a display device—mobile smart device, personal computing device, etc.) based on the user profile generated by the profile component 116. The streaming component 122 is further configured to communicate the video content from different media sources of a plurality of media sources at different times based on the user profile. Further, the streaming component 122 can operate to communicate different video content from different media sources at the same time at different personalized channels 107, or at the same channel for interacting with one type of content and viewing another, such as video chat with various client devices while viewing the video content from media sources at the same time.

In another embodiment, the computing device 104 operates to stream video content via the streaming component 122 from various media sources at prescheduled timing and based on the user profile. The user can set the content, times and media sources with user preferences and also have updated content dynamically provided as selections. The computing device 104 can operate to recommend or suggest configurations (video content, scheduling, media source options) based on the user profile information already obtained and that is being dynamically learned by the system 100. In addition, a different mobile device or display component could access the channel 107 remotely to view what the user is viewing, or the same video content. The different additional display device/component to the display component 106 could also provide comment and/or interaction regarding the content via the channel 107, which is further discussed below.

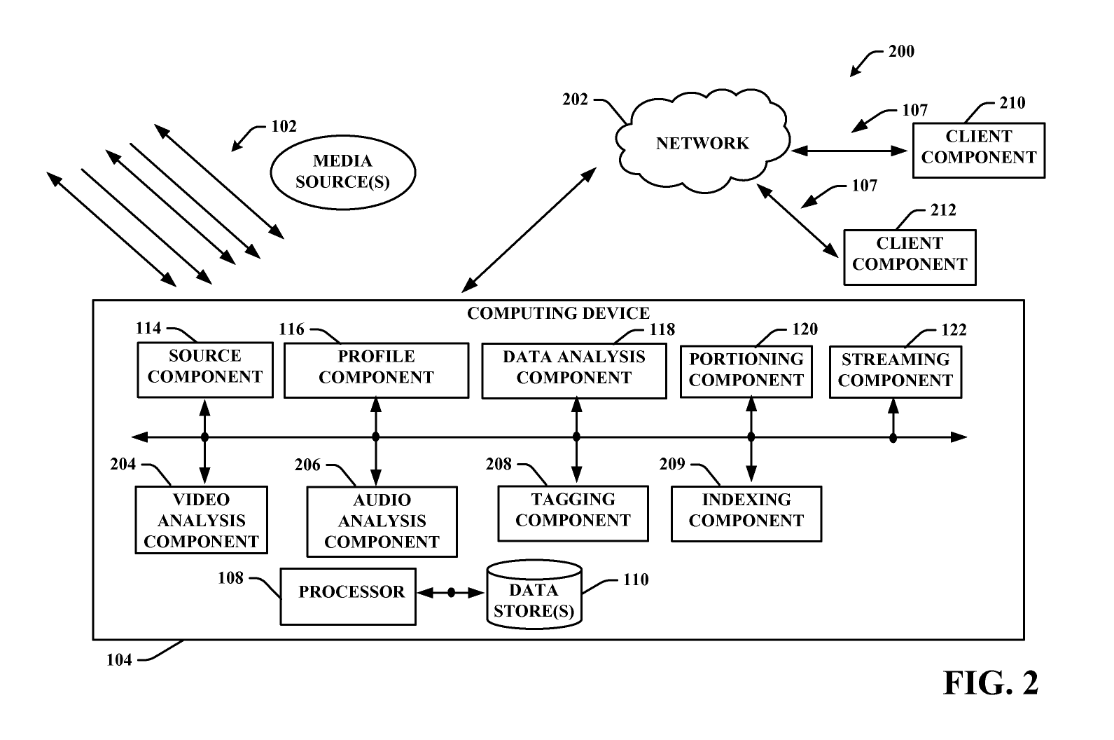

Referring to FIG. 2, illustrated is an example system 200 for generating personal media viewing in accordance with various embodiments described herein. The system 200 operates to obtain media content from media sources 102 such as from social networks 202, online news data feed, video services and other web pages/sites, and further aggregates the media sources into a personalized viewing channel 107 based on user profile data and predicted video content. The personalized viewing channel 107 operates as a configurable user video channel that can be configured by the computer device 104 to provide programming (e.g., video content, or other media content) as a series of personally scheduled content from various media sources that broadcast, post, feed update, upload, etc. programming for general viewing and/or subscribed viewing. The programming, video content, and/or media sources communicate via the personalized channel 107 can be configured based on user profile data identified by the client component 210, for example. The personalized video channel 107 can then operate to be subscribed to, viewed at certain times, and/or freely available to other client components 212 (e.g., mobile devices), in which the client component 210 can control via user profile data.

In one embodiment, a client component 210 could set user profile data to transmit video content via the personalized video channel 107 according to a particular mood, a particular interest, a specific activity, a genre, a producing studio/company, an actor/actress, a language, a country/demographic, and the like preference or classification. The user profile data is utilized by the system to predict viewing likes, dislikes, scheduling, media sources, particular video content, and the other video habits to program or configure the personalized channel 107 for viewing by the client component 210, which could be a source of the user profile data, and/or for multiple other client components 212. The computing device 104 further comprises a video analysis component 204, an audio analysis component 206, a tagging component 208, and an indexing component 210.

The audio analysis component 204 is configured to analyze audio content of the media content and determine portions of the audio content that correspond to the set of words or phrases of a topic designated by the user profile data. The audio analysis component 204 operates to identify one or more words or phrase that match the topic and identify an audio transition of the video content based on one or more audio criteria. The set of audio criteria can comprise, for example, a change in vocal tone with respect to time, a change in voice, and/or a change in a frequency of detection with respect to time of the topics. The frequency of detection can be a number of times the topic is mentioned in the audio content, such as the word “weather” or “earthquake” if a user is wanting to identifying video content discussing a recent earthquake event, for example. The audio analysis component 204 can analyze the media content for portions within media content having a matching word or phrase in the audio content of the media content. The portioning component 120 can receive the audio transitions to further identify segments of video content and/or extract the portions with the matching word or phrase in the media content (e.g., video, and/or audio). The media content portion, for example, can be a video segment with an actor saying the word or phrase, for example, as well as a song, speech, musical, etc.

The audio analysis component 204, for example, can identify information from audio signals for analysis, classification, storage, retrieval, synthesis, etc. In one embodiment, the audio analysis component 204 recognizes words or phrases within a set of media content, such as by performing a sound analysis on the spectral content of the media content. Sound analysis, for example, can include the Fast Fourier Transform (FFT), Time-Based Fast Fourier Transform (TFFT), changing the form of the audio spectrum or signal change and/or other like tools. The audio analysis component 204 is operable to produce audio files extracted from the media content, and analyze characteristics of the audio at any point in time, or along the entire audio spectrum of the content. The audio analysis component 204 can operate to generate a graph over the duration of a portion of the audio content and/or the entire sequence of an audio recording that can be pre-associated with and/or not pre-associated with video or other media content (e.g., video content, audio books, songs and the like). The portioning component 120 can thus identify portions of the media content based on the output of the audio analysis component 204, such as part of the set of predetermined criteria upon which the extractions and/or transitional boundaries between different audio and video segments can be based.

The audio analysis component 204 can operate to use specific features of speech to determine the speaker, actor, performer within the content. The system 200 thus operates to divide video files into video stories (segments, portions of segments) by determining the boundaries of media content is an analysis of the video via the video analysis component 206, and also by determining the boundaries of media content by an analysis of audio via the audio analysis component 204.

In one embodiment, the audio analysis component 204 is configured for speech recognition (e.g., translation of spoken words to text). The audio analysis component 204, for examples, operates to discern which voice belongs to whom within the audio portions of video content portions. The voice ownership, for example, can be distinguished between portions of content so that one speaker is recognized over another speaker for purposes of determining transitions and transitional boundaries throughout the media content (e.g., audio/video content), such as when one voice begins to speak and when the one is finished and another began, in addition to what is being said by announcer or commentator. Thus, the audio analysis component 204 can operate to aid in further defining boundaries of plots or topics with speech analysis. In other words, the boundary of the plot can be factored as between “talking” of two different people. Here, the audio analysis component 204 determines to a degree who is speaking, what is being said, and when started/finished speaking. In determining who speaks, audio content or voice content can be passed through a series of filters and transformations that result in a range of values that are unique to each individual.

In another embodiment, the audio analysis component 204 received an audio stream from the original video content/segment/portion and operates to transform it by increasing the level of the signal bit rate reduction and make a sound channel (mono), in order to reduce computational complexity. The audio analysis component 204 compensates the audio with high pass filters for the attenuation in the audio data, such as with speech signal attenuation (reduction in signal intensity—e.g., 20 dB/dec), and thereby increase the relative value of the higher frequencies to the low frequencies. The audio analysis component 204 can divide the data/audio stream into fragments (images) from a ceiling. The number of boxes/fragments received will depend on the size of the window of analysis and the amount of overlap. This is done to reduce the computational complexity of the problem and to gather information that might arise at the window borders. Further, in order to minimize the signal discontinuities at the boundaries of each window, each frame (window) can be multiplied by the cosine window function (e.g., by applying a sliding window or a statistical running window). The treated frames thus have the same number of data points. For example, Window function W(N), the length N (window size) is determined by the following formula: W (n)=(1−a)−(a*cos ((2*Math.PI*n)/(N−1))). For example: the value of 0.46 for alpha or “a” value can be the Hamming window. The window size can be approximately 25,625 ms for the frequency of 16 kHz, thus obtained 410 samples in each window (frame). The audio analysis component 204 use the discrete Fourier transform (FFT) for each received window. The Fourier transform enables an expansion of the signal to its frequency components. In addition, the amplitude and the power spectrum are determined for speech recognition.

The audio analysis component 204 can operate in the Mel scale, such as by computing the Mel-Cepstral coefficients of each window of data obtained. The audio data can be filtered in the power spectrum. Feature vector encoding the individual characteristics of the speaker's speech comprises factoring these small-Cepstral Coefficients accordingly. The general model for the relationship between the frequencies in Mel and linear scale is expressed as: melFrequency=2595*log (1+linearFrequency/700). The minimum and maximum frequencies determine the frequency range, “stretch” of the filters. These frequencies depend on the parameters of the audio signal (sampling rate). The maximum frequency could be lower than the Nyquist frequency that is half the sampling frequency.

The audio analysis component 204 operates feature vector encoding of the individual characteristics of the speaker's speech. If the audio stream data is identified as having similar feature vectors, then it says the same people are communicating. Once the audio analysis component 204 determines that the other person started to talk, a possible candidate is designated for the boundary of the plot (after no mandatory pause/silence).

In another embodiment, to identify “what is being said” a Cepstral Mean Normalization (CMN) can be applied in order to reduce the distortion caused by the transmission channel. For example, the calculated Cepstral mean approximately describes the spectral characteristics of the transmission channel (e.g., a microphone) and subtracted (“removed”) from data obtained in the previous step. At this point, there is a reduction in sensitivity to the voice, and the audio analysis component 204 can remove individual features of the speaker's speech (“impersonality”). The audio analysis component 204 can then fill feature vector time changes, in which other than true Cepstral coefficients are added to the first and second derivatives (delta data). The inclusion of derivatives in the feature vector can also reduce the effect of convolutional distortion, due to the fact that these distortions usually change slowly over time and are additive in the Cepstral domain. The speech recognition can obtain a resulting feature vector for phonemes, diphthongs, syllables compare with patterns set in an acoustic model of the language. From these syllables, based on the dictionary, a make-up words can result, in which tags to the boundaries can be generated and used to indicate plot boundaries to select those segments or portions of video content that reflect what a particular performer or actor actually said, for example.

The video analysis component 206 is configured to identify a video transition of the video content of the plurality of media sources based on a set of video criteria. The set of video criteria, for example, can comprise a difference of at least one of a scene setting (e.g., a time of day, a place/location of action, a landscape or environment, weather condition, etc.), one or more actors/performers, a view/picture setting (e.g., color, brightness, contrast, sharpness, tint, etc.), a first difference threshold of frames being satisfied, and/or a second difference threshold in objects recognized. For example, a differential between frames can indicate a change in video segments for a news broadcast where a change in scenery or change in contrast is a certain level such as a number of objects changing exceeding five or a different number.

In one embodiment, the video analysis component 206 can identify transitions that are within a video segment while excluding commercial content so that transitions are recognized as pertaining to a change in topic within a scheduled video content or program from a media source such as a news broadcast. The change in content can include ranges for frame comparison and audio comparisons via the audio analysis component 204 in order to determine whether content is commercial or part of the regularly scheduling programming for the time slot. For example, picture settings could vary from a video content and commercial video content greater than from within the video content programming. Different ranges for tolerance with the set of video criteria could be used to indicate variances within the programmed video content, such as a news broadcast as opposed to commercial content.

The video analysis component 206 can comprise a set of filters, for example, that operate to analyze frames of video content as a sequence of images, which are alternately passed through the set of video filters that provide a vector of real numbers describing the result of the filtering. With an array of vectors for each image, the video analysis component 206 can calculate a correlation between paired adjacent images, such as a Pearson correlation between the vectors. For example, the video analysis component 206 can compare results of filtering for edge detection for the left frame with the results of the same filter for the right frame. If the similarity ratio below a certain threshold (calculated dynamically in the preliminary analysis of the video), then the video analysis component 206 can consider that compared frames belong to the same plot. However, if the ratio is above the threshold of similarity, the frames are in different subjects. In the latter case, the time is saved and the end of the current chapter begins for the new current plot. As a result, a sequence of frames can be identified on the basis of the video stream, with portions including stories from the beginning and end of each. In addition to comparing the results of filtering, the video analysis component 106 can operate a matrix subtraction to determine differences between frames.

In another embodiment, the video analysis component 206 can operate to determine and allocate transitions/boundaries and/or contours of objects in order for transitions in sequences of video content to be tagged and indexed. The video analysis component 206 can determine the transitions/boundaries with a per-pixel subtraction, a histogram of colors, recognition of specific objects and their changes from frame to frame, for example. The analysis from both the audio content and the video content via the audio analysis component 204 and the video analysis component 206 can be obtained, compared and used together to determine transitional boundaries within video content and tag the boundaries with time stamp data, subject matter data, topics and other classification criteria for future reference and mapping in an index.

The tagging component 208 is configured to associate a tag having metadata to the portions of the video content from the media sources. The metadata can comprise a time of the video content from a corresponding media source of the plurality of media sources, a location comprising a city or region, a device type for compatibility, audio indicators and video indicators of boundaries or transitions. In addition, a frequency of detection of various words, phrases, and a designation of who is speaking at what times and the number of different speakers for each segment can be included as part of the metadata, as well as a frequency of detection of a topic. The metadata can also include a ranking for the topic to be identified or not based on satisfying a predetermined rank threshold based on a frequency of detection of the topic.

The indexing component 209 is configured to index media content and portions of media content portions according to a set of criteria. For example, the indexing component 209 can index the portions of media content according to words spoken, or phrases spoken within media content portions. For example, if the phrase “It is all good” is identified in a set of media content such as a video and/or an audio recording and portioned by the portioning component 120, then the indexing component 209 can store the portion of the media content with a tag or metadata that identifies the portion as the phrase “It is all good.” The segment of media content with the audio content “It is all good” can then be retrieved from the media source or a stored data store of the system 200 and the portion (segment) can be streamed to a client device via the personalized video channel 107.

In one embodiment, the indexing component 209 indexes the media content based on a particular video or audio that is selected for extraction or portioning by the portioning component 120. Particular media content, such as particular movie, song, and the like, can be indexed according to one or more classification criteria of the particular media content. For example, classification criteria can include a theme, genre, actor, actress, time period or date range, musician, author, rating, age range, voice tone, and the like, which could be set by the user preferences of user profile data. The computer device 104 can thus analyze media content from media sources 102 for indexing tags by the indexing component 209, and/or index media content stored to predefine categories of media content and/or media content portions. In addition, the indexing component 209 is configured to index portions of media content that are extracted or identified as portions. The indexing component 209 in communication with the tagging component 208 can tag or associate metadata to each of the portions as well as the media content as a whole for indexing the tags, metadata and/or the portions. The tag or metadata can includes any data related to the classification of the media content or portions related to the media content, as well as words, phrases or images pre-associated with the media content, which includes video, audio and/or video and audio pre-associated with one another in each portion extracted, for example.

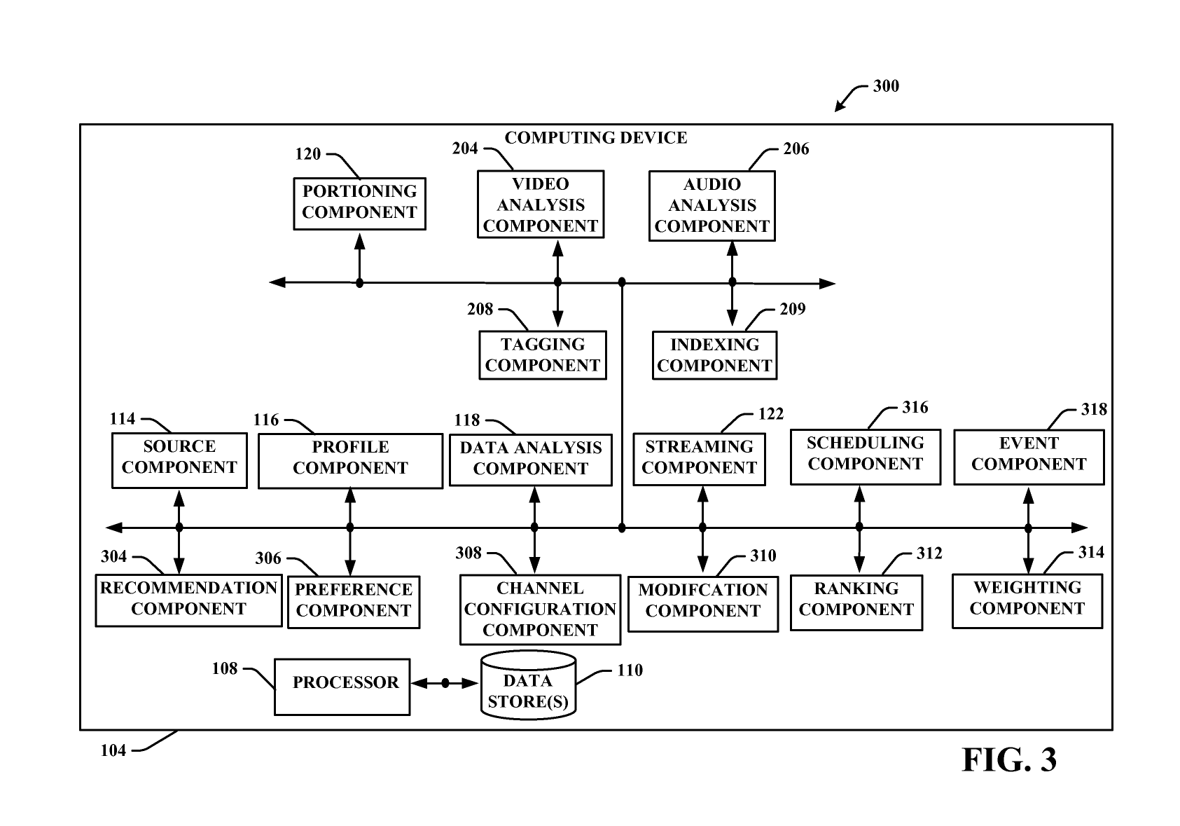

Referring now to FIG. 3, illustrates another example system 300 having similar components as discussed above to configure a personalized video channel or channels from video content of different media sources to one or more mobile devices. The system 300 continuously identifies media sources 102 and video content from the media sources 102 for streaming via a personalized video channel 107. The computing device 104 operates to add media source(s) to the media source(s) 102 and/or remove media source(s) from the identified media source(s) 102 as additional media source(s) are identified, become available, subscribed to and/or manually added/canceled by a user device or component (e.g., the mobile device 210 and/or 212). The computing device 104 can be further configured to associate different sets of media sources to respective mobile devices 310 and/or mobile device 212, and/or to different personalized video channels 107 based on user profile data communicated from the authorized user device/component (e.g., mobile device 210 and/or 212).

For example, a personalized channel 107 can be communicated to a subscribing device or mobile device 212 can be configured for viewing at defined times from an online video subscription service with particular video content while another personalized video channel 107 can at the same time be configured to communicate video content from a broadcasting local, for example, or other media source channel at a defined time to the mobile device 210. The mobile device 210 and the mobile device 212 can communicate to one another in a wired connection and/or wirelessly on the same wireless network or different network 202 as one another, which can include a Wide Area Network (WAN), Local Area Network (LAN), a cloud network and/or the like. The system 300 comprises the computing device 104 further comprising a recommendation component 304, a preference component 306, a channel configuration component 308, a modification component 310, a ranking component 312, a weighting component 314, a scheduling component 316, and an event component 318.

The recommendation component 304 is configured to recommend the video content based on the user profile, as well as recommend portions of video content and/or further media sources upon which to derive video content for communication via one or more personalized channels 107, 302. The recommendation component 304 can operate to communicate a set of recommended media content, media content portions (i.e., segments of media/video content) based on a set of classification criteria (matching audio content to search terms, theme, genre, audience category, language, location, actor/actress, a personal video classification based on metadata, and the like) and/or user profile data such as user preferences, which can include topics selected for past, current and/or future viewing content. For example, the set of user preferences can include a selection of video content from media sources 102, in which recommended video content and portions of the video content can be identified.

The recommendation component 304 operates to further narrow searching or identification of media content portions (e.g., segments of at least one of scheduled programming, video content, video feeds, social networking sites, video subscriptions services, and the like) within media content and video content (e.g., identified programming, movies, videos uploads, etc.) from the set of media sources 102. Because the volume of media content can be large from multiple different data stores/sources with different broadcasting channels, and/or web pages, the recommendation component 304 can further focus the generation of video content and associated portions to a subset of recommended video content (e.g., programming) and/or portions (e.g., segments of programming, such as news clips within a news broadcast), and provide options via mobile devices 210 and/or 212 to configure a personalized channel 107 with other video content and/or media sources other than predicted content automatically scheduled by the system, and/or other prescheduled configured content/media sources. In this way, various types of refined preferences can be used for various types of objectives as they are modified and/or entered into the user profile dynamically. For example, specific cultural significances, specialty significances, educational objectives, audience categories, language preferences, racial preferences, religious preferences, and the like can be used to generate portions of media from larger volumes of media content and from video content of various media sources, which can be defined in addition to other more standard preferences such as a theme (comedy, romance, drama, etc.). A user not satisfied with previously programmed content for the channel, either predicted and/or previously configured can search content via the network 202 in a search engine component (not shown) while being supplemented with recommendation options at the same time via the recommendation component 304. Therefore, the user can be presented with recommended content as identified by the system 300 from identified media sources 102 and also search results based on the search terms from the user's own search over particular/specified/other data stores.

The preference component 306 is configured to communicate preference selections received via the mobile device 210/212, such as via a graphical control and/or the like. The set of user preferences, as discussed above, can comprise at least one of a media source preference, a time preference to associate with the video content, a personalized channel selection, a theme preference, a rating preference, an actor preference, a language preference, a date preference, past viewing configurations and/or other preferences for media content and media sources. In one embodiment, the preference component 306 can provide options for preferences to a user via a personalized video channel 107 and to at least one of the mobile devices 210, and/or 212. The preferences can be received as selections for configuring the personalized channels at different times of a schedule and/or learned dynamically from user behavioral data that represents user control inputs related to video content and/or identified media sources 102.

The channel configuration component 308 is configured to modify the personalized video channel 107 to communicate video content based on predicted video content that is automatically scheduled by the system 300 according to user profile data and/or based on the set of user preferences of the user profile data for manual configuration by the user. The channel configuration component 308 enables a plurality of channels to be configured and further communicate personalized video content from a plurality of media sources to one or more mobile devices 210, 212. A set of user profile data can be assigned to the respective channels 107 independently so that the channels can be configured based on respective sets of user profile data (e.g., user preferences and/or behavioral data). For example, a channel 107 can be configured to communicate a first set of media sources with a first set of video content at different times and/or video content portions from at least two of the channels, and another channel could be configured to communicate a second different set of video content and/or video content portions. Further, both channels 107 could be configured based on the same set of user profile data, in which the channel 107 can be configured from one set of media sources to communicate cartoons, for example from a first broadcast station, and subsequently programming from another broadcast station, while the other channel is configured to provide content from different media sources at the same time. Thus, the same user profile could enable a single household to access various programming configured to different channels from different mobile devices as well as access one or the other channel from the same mobile device, in situations where interest could change depending on a user's mood. In addition or alternatively, both channels 107 could be communicated to the same device 210, 212, in which video content could be displayed alongside, in front of or behind the other video content streaming in different view panes.

The modification component 310 is configured to modify the video content, the plurality of media sources and/or a scheduled time for communicating the video content and/or media source(s) in response to a user input selection. The modification component 310 can modify one or more of the configuration channels and/or media source(s). For example, the modification component 310 can operate to change from one personalized channel 107 to another personalized channel for a particular mobile device 210 for example. The channel 107 could be controlled via user profile data from the mobile device 210 and/or a different mobile device, such as mobile device 212, in which the mobile device 210 receives authorization to receive content via the personalized communication channel 107 from the other mobile device 212, or vice versa.

The modification component 310 can operate to alter content at a given time through a selection input or other input control received via a user device, such as mobile device 210 and/or 212. For example, a media source could be changed from a play list of options via a user selection. The modification component 310 can operate to control the prediction grid of the prediction grid component by modifying settings for display of the grid. For example, the prediction grid could show a history of predicted content for a particular time, whether past, present and/or future along the time line or time axis based on predicted content for the time. Alternatively or additionally, the modification component 310 can modify the basis for providing predicted content as dependent upon current recommendations in order to demonstrate viewing trends by which the system 300 can further predict viewing content at particular times, dates for various media sources and video content (programming) from the media sources.

Additionally or alternatively, the modification component 310 can modify the number or the amount of different video content that is provided to a mobile device 210 via the personalized channel 107. For example, a video could be communicated from a broadcast that is either being aired at a broadcast scheduled time, an additional chat screen could be generated for discussing video content, and/or video screen for video communicating with one or more other mobile devices at the same time. In addition, the number of screens for viewing content from different media sources could be modified in order to dynamically search for other video content and sources while viewing other video content and media sources.

The modification component 310 can also operate to configure a media source preference, a time preference to associate with the video content, a personalized channel selection, a theme preference, a rating preference, an actor preference, a language preference, a date preference, past viewing configurations and/or other preferences to the video content and media sources that the video content is derived from. For example, as a user continues to watch a particular series at a particular time, either broadcasted from a station as the source or streamed from an online site or feed, the system can alter a preference for the episodes/series/source to be associated with the particular times. The modification component 310 can dynamically interact with a user via the mobile device 210 for determining preferences, inquiring further about preferences at times, and/or modifying the set of behavioral data from user inputs related to different video content. For example, when an episode from a broadcast is not programmed at the usual time due to alternative programming, other predicted programming could replace it, while the system inquires further or indicates as such to the user for further override or input (via behavioral data and/or preference selections).

The ranking component 312 is configured to generate ranks for video content, preferences, and/or topic frequency associated with video content for viewing via the personalized video channel 107. For example, the ranking component 312 is configured to generate a rank that corresponds to the topics based on a frequency of detection in the video content from the media sources.

Video content can be identified as a possible selection from among many different media sources, such as an RSS feed, a video subscription service, web page, web portal/site, a broadcast (wirelessly/wired), social networking site, personal video libraries and like media sources. In order to ascertain what content could be preferable to the user, the ranking component can dynamically rank identified video content based on topics within the video content. In other embodiments, the video content can be ranked according to the correlation with other user preferences (e.g., likes, dislikes, settings for content) and/or classification criteria (e.g., language, audience category—PG, G, etc., other ratings, genre, performer, etc.) as identified or set by user profile data. Additionally or alternatively, video content can be ranked based on the physical/digital characteristics of the video content (e.g., resolution quality, duration, color quality, sound quality, etc.), in which video content satisfying a predetermined threshold for video/audio quality are kept and other video content be discarded.

The ranking component 312 operates to narrow or focus the identified video content and media sources identified over airways, network connections (e.g., network 202), satellite content, cable content, local broadcast stations and other media content sources that provide video content such as through RSS feeds, and/or other web data feeds. In one embodiment, the ranking component 312 can rank the media sources based on a set of media source criteria that can include preferences for a user, topics, media source quality rating for video content and the like. The ranking component 312 can thus operate dynamically as new and updated video content and media sources are identified to communicate with the streaming component 122 for streaming video content from media sources that are ranked in a top percentage tier, that have a high percentage of correlation to the user preferences, including topic preferences for specified time slots, quality preferences or factors, and/or classifications of the video content/media sources.

The weighting component 314 is configured to associate a weight to the video content of the plurality of media sources based on the rank. The weight can be associated to video content that is of a certain rank threshold and/or filtered for selection from the ranking component 312 discussed above. The weight of the video content can also be associated based on other user profile data, such as how well the video content is ranked according to the video content matching user preferences and corresponding to the behavioral data ascertained about the user's habits for particular video content.

For example, video content from an RSS feed can be weighted from one media source different from another media source based on the rank and the user behavior data, and/or further based on other user profile data. RSS feeds and/or feeds as discussed herein can comprises a group of web feed formats used to publish frequently updated works—such as blog entries, news headlines, audio, and video—in a standardized format. An RSS document (which is called a “feed”, “web feed”, or “channel”) includes full or summarized text, plus metadata such as publishing dates and authorship, which can be used to identify, communicate, obtain and/or render video content associated with the feed. RSS feeds or feeds, for example, can benefit publishers by enabling them to syndicate content automatically. For example, an XML file format allows the information to be published once and viewed by many different programs. They benefit readers who want to subscribe to timely updates from favorite websites or to aggregate feeds from many sites into one place.

RSS feeds can be read using software/hardware called an “RSS reader”, “feed reader”, or “aggregator”, which can be web-based, desktop-based, or mobile-device-based. The user subscribes to a feed by entering into the reader the feed's URI and/or by clicking a feed icon in a web browser that initiates the subscription process. In one embodiment, the source component 114 can at least partially operate as an RSS reader that checks the user's subscribed feeds regularly based on the profile data generated via the profile component 116 for any updates that it finds, and provides a user interface to monitor and read the feeds. The computing system 104 further operates to identify and updated broadcasted data, subscription sites without RSS feeds, but that provide video rental, channel episodes/programming and the like based on a regular or periodic subscription service. The computing device 104 operates therefore to help a user avoid manually inspecting all of the websites, channels, as well as social sites (e.g., Facebook, Twitter, etc.) and subscription services for download, such that new content is automatically checked for and advertised by their browsers as soon as it is available and recommended to the user for viewing via the personalized video channel 107, for example.

The scheduling component 316 is configured to generate a predetermined schedule of video content from the plurality of media sources via the personalized video channel 107 based on the user profile, including user preferences and/or behavioral data of the user's video viewing. The scheduling component 316 operates to manage scheduling operations and data from the media sources identified and extracted for video content. In one embodiment, the scheduling component 316 can aggregate data from the media sources 102 and/or other web pages in a data store as metadata. For example, the metadata can be provided from one of the media sources (e.g., CNN or other source) and/or be from a media source that does not have associated video content (e.g., tvguide.com), but provide associated programming data such as scheduling times, programming title, content information, other metadata, etc. associated with various programming of one or more of the media source content, in which programming can be a defined time of video content, content of a particular title, genre, and/or other classification of video content (e.g., a television or viewing guide web page).

In another embodiment, the scheduling component 316 controls timing aspects of the personalized channel 107 based on the user profile and associated data for the personalized channel 107. For example, a popular reality show from a web page and/or broadcast could be communicated via the personalized channel at a specific time and consecutively follow-up with a Facebook news feed of friends via the same channel. As such, content from different media sources can be scheduled at predetermined times that are different from the pre-scheduled programming times of the media source in which it originated or from updated times. For example, video content from a first media source of a first time can be rendered to the display component at a user defined time and video content from a second media source at a second time can then follow and/or be scheduled for other times. This can enable the user to have dynamic video content from multiple different media sources at user defined scheduled times and interact dynamically via the user profile with updated content, viewing options and/or present newly participating or discovered media sources for video content to be communicated from as selections for being rendered, to be followed for updates and/or for portioning into partitions.

In another embodiment, the scheduling component 316 can operate to schedule portions of programming based on the user profile. For example, a certain topic of interest could be classified by the user preferences to predominate the selected personalized channel 107 at a particular time, such as content pertaining to a local disaster or pending disaster, as well as any other topic. Other aspects of the user profile can also be used as the portioning criteria, such as age category, audience rating, user interest, behavioral data representing user input controls related to video content (viewing, fast forwarding, skipping, purchasing, searching as search criteria, etc., as input actions. Segments or portions of subsets of videos or programming related to a local event can be extracted or spliced at transitions points (e.g., points between news stories within an hourly news broadcast or some other interval scheduled broadcast) to provide programming related only to the specific topic. The channel can be dynamic in real time, or, in other words, based on programming from media sources at the present time, and/or encompass programming that has already occurred within a certain defined time and has been recorded or stored in a data store. The programming recorded/stored can then be introduced among options for communication/viewing via the personalized channel 107 as user defined times rather than broadcast and/or updated times.

Additionally, the programming of scheduled video content and/or updated content can be performed via the channel 107 as selections by the user. New updated content from the plurality of media sources can be presented first while older content can follow in an order of relevance of a listing. The scheduling component 316 can then receive selection for one or more of these and scheduling options (e.g., times, dates, store, scrap, etc.) for rendering via the channel 107. For example, a user could desire to have history rendered via the channel 107 on Saturday nights with video content that is from other times and/or at the programmed times and then have a news feed from a different channel aired at a different previous time or in real time after the history programming. Times, dates and the channel 107 can be programmed based on the user profile data for any number of channels, media sources, video content, content options and/or portions of content to be rendered via the channel 107.

The event component 318 is configured to associate metadata to respective video content of the video content from the plurality of media sources. The metadata can comprise one or more (e.g., at least two) of a time of the video content from a corresponding media source of the plurality of media sources, a location (e.g., a city, location and/or region), a device type for compatibility (e.g., wide screen, HDTV, radio, handheld, smart phone, etc.), and/or a top tier of video content having a rank that satisfies a predetermined threshold and/or can also be associated with a frequency of detection of a topic from the video content of the plurality of media sources. The event component 318 can operate to reduce and/or raise a weight by associating metadata to the video content based on one or more events that include user behaviors, a change in topic selection in the preferences of the user profile data and/or of the video content. As such, the ranking component 312 can operate to reconfigure a rank based on the change in data associated with the video content and/or data set within the user profile data by a user and/or learning of the user's behavioral patterns toward various video content and/or media sources. The weighting component 314 operates to then reconfigure a weight associate with video content analyzed and identified from the media sources.

The streaming component 122 is thus operable to communicate a sequence of the video content from the plurality of media sources, as well as communicate various media content portions based on user profile data, ranks, weightings and associated metadata of video content identified for a dynamic user experience that can be predetermined on a schedule for the user automatically and/or selected by the user, in which the system further adapts for dynamic scheduling thereafter. For example, the streaming component 122 is configured to communicate an updated video content selection (e.g., a new episode, a new video from an identified friend on a social network, an updated of a social network news feed, a broadcast content programming at a certain time, title, or other related criteria data) as well as portions of each based on classification criteria. A display component such as a client component 210 is configured to receive the communicated content via the channel 107 and render the content to a display (e.g., a touch screen, panel display or the like) that generates the updated video content associated with the updated video content selection in the display component via the personalized video channel 107 in response to an updated video content selection input being received.

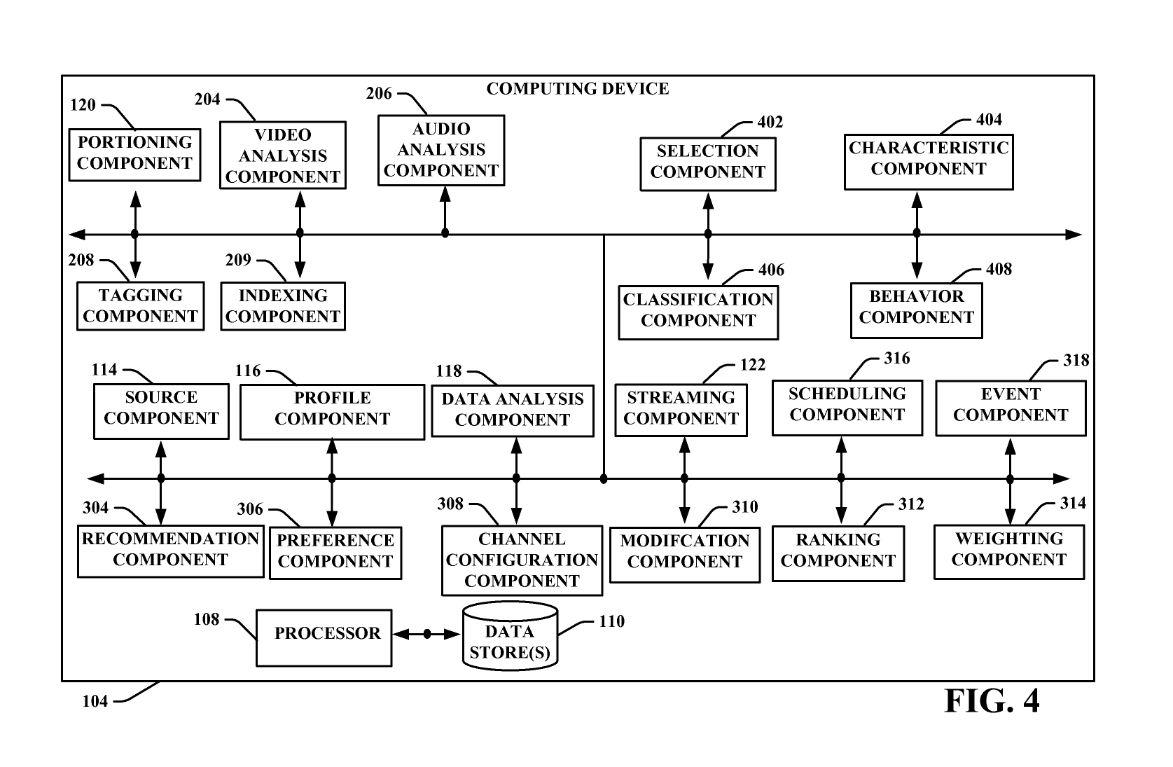

Referring to FIG. 4, illustrated is a system 400 for one or more personalized video channels in accordance with various embodiments described in this disclosure. The system 400 includes the computing device 104 with the components discussed above and further includes a selection component 402, a characteristic component 404, a classification component 406 and a behavior component 408.

The selection component 402 is configured to communicate the video content as a set of selections to respectively schedule at a predetermined time in a display component for rendering the video content at the predetermined time. The selection component 402, for example, operates with the scheduling component 316 to provided options to the user in forms of selections for video content. The selection component 402 can receive a video content selection, a media source selection, a portion/segment of video content selection, a selected data store and the like for viewing via the personalized video channel 107. The selections can also be in the form of touch screen selections that are received, box checked selections, a drop down selection and/or any other graphical user interface control for a selection that operates to receive a user's desire for one of the video content, segments, media source, etc. for viewing. The selections can also include times corresponding to a grid, such as a prediction grid, in which the user can associate the selection to a selected time or times for viewing along the grid.

For example, a user can select video content identified from different media sources (e.g., an RSS feed, a news source, a reality show upload from a subscription service, etc.) and schedule the personalized video channel 107 to stream from the different media sources at the different times, ether sequentially in consecutive order or in another sequence. The user can then leave to go to a different location or region with a friend where the user can plug-into the personalized video channel with an application interface to stream the scheduled content at the times configured with the video content selected and from the different media sources, such as for a broadcast video, a personal video, web data feed video content, subscription service online video content, store video content, broadcast content from the local area of configuration, and/or from the location of viewing, for example.

The characteristic component 404 can operate to determine characteristics of the video content identified from the different media sources. The characteristic component 404 is configured to analyze a set of characteristics related to the video content that include a video resolution, a duration, and/or one or more colors for determining black and white content, as well as colored video content. Video evaluation mathematical models can be utilized by the characteristic component 404 to approximate results of subjective quality assessment of video content, which are based on criteria and metrics that can be measured objectively and automatically evaluated by a computer program. Objective methods can be classified based on the availability of the original video signal, which is considered to be of high quality (generally not compressed). Therefore, they can be classified as Full Reference Methods (FR), Reduced Reference Methods (RR) and No-Reference Methods (NR). FR metrics compute the quality difference by comparing pixels in each image of the distorted video to its corresponding pixel in the original video. RR metrics extract some features of both videos and compare them to give a quality score. They are used when all the original video is not available, e.g. in a transmission with a limited bandwidth. NR metrics try to assess the quality of a distorted video without any reference to the original video. These metrics are usually used when the video coding method is known. Other ways of evaluating quality of digital video processing system (e.g. video codec like DivX, Xvid) that can be utilized are calculation of the signal-to-noise ratio (SNR) and peak signal-to-noise ratio (PSNR) between the original video signal and signal passed through this system. PSNR is the most widely used objective video quality metric. In addition, other metrics can be utilized such UQI, VQM, PEVQ, SSIM, VQuad-HD and CZD.

The classification component 406 is configured to determine a classification of the video content from the plurality of media sources. The classification can include a theme, an age range, a media content rating, an actor or actress, a title, or a category according to the user profile data, wherein the category includes a news broadcast, a movie, a branded channel, and/or a television series. The classification can be set according to a user preference, identified from analysis of the video content and/or metadata associated with it, and tagged by the classification component 406 to the video content, which can be indexed thereafter according to the classification for further ease of retrieval by referencing the tags in the data store 110.

In one embodiment, the classification component 406 operates to identify audio content associated with the video content. The classification component 406 further determines whether audio content of the video content matches a word or phrase of a search criteria represented in the user profile data. The system 400 can thus operate to retrieve a word or phrase such as for a topic request and ascertain via the audio content words and phrases for matching with the topic requested.

The classification component 406 can also ascertain semantics about the video content, such as actors, performers, time period of production, subject matter, genre, etc. according to various attributes of the content. For example, the audio content could give clues to each of these as well as the title, and other metadata associated with the video content. The video content can have multiple attributes that aid in classification of the video content via the classification component 406, for example. The classification component 406 can utilized the classification data of the video content for matching with classification criteria set in the user profile data by the user and for the system to provide recommended video content from different media sources accurately.

In another embodiment, the classification component 406 identifies type of video content according to a category including a news content, a movie, a branded channel (e.g., Discovery, BBC etc.), and/or a television series/episode, for example. A movie can be labeled according to a genre and time, for example, in order for the streaming component to queue for streaming via the personalized video channel 107.

The behavior component 408 operates to identify a set of behavioral data that represents user input control inputs received to manage the video content. For example, a purchase, a search term, viewed content, controls pertaining to video content and the like can be determined and used to determine a rank for video content via the ranking component 312. Other user controls to the video content can include an amount of a video content from a particular source that the user views and reduce or increase the rank of the content based on the behavioral data. For example, viewing less than 30 seconds could reduce the rank and the associated weight of the content, whereas viewing more than 99 percent of a video content could increase the rank and associated weight. The video content would then have a greater likelihood of being presented to the user as a future option or related video content associated with the same episode, programming, media source and the like related content, for example. Other behavior could also be associated with a strengthening or reduction of rank and weight to video content that are ascertained via the behavioral component 408. For example, rewinding actions could provide a rank/weight reduction, and rating of the content by the user on a scale could also decrease or increase the corresponding rank/weight for the content. For example, a five start system of rating could correspond with a neutral or no change at 3 and any rating below or above three could provide a corresponding increase or reduction in rank accordingly to the video content, the topic of the video content, the media source and/or segments of the video content.

The streaming component 122 is thus operable to communicate the video content from the media sources, as well as communicate various media content portions based on user profile data including user preferences for content/media sources, timing/scheduling content, ranks, weightings, classifications, selections and associated metadata of video content identified for a dynamic user experience that can be predetermined on a schedule for the user automatically and/or selected by the user. For example, the streaming component 122 is configured to communicate an updated video content selection (e.g., a new episode, a new video from an identified friend on a social network, an updated of a social network news feed, a broadcast content programming at a certain time, title, or other related criteria data) as well as portions of each, based on classification criteria, rankings of the video content, the user preferences, behavioral data and weighting provided to each of the classification criteria, the user preferences and topics determined for video content identified. A display component such as a client component 210 is configured to receive the communicated content via the channel 107 and render the content to a display (e.g., a touch screen, panel display or the like) that generates the updated video content associated with the updated video content selection in the display component via the personalized video channel 107 in response to an updated video content selection input being received. Video content can be updated either via the media source providing the video content such as through an RSS feed and the like, or by a reduction or increase in rank for topics and/or other criteria of the user profile data, and/or classification that changes a weight of the video content.

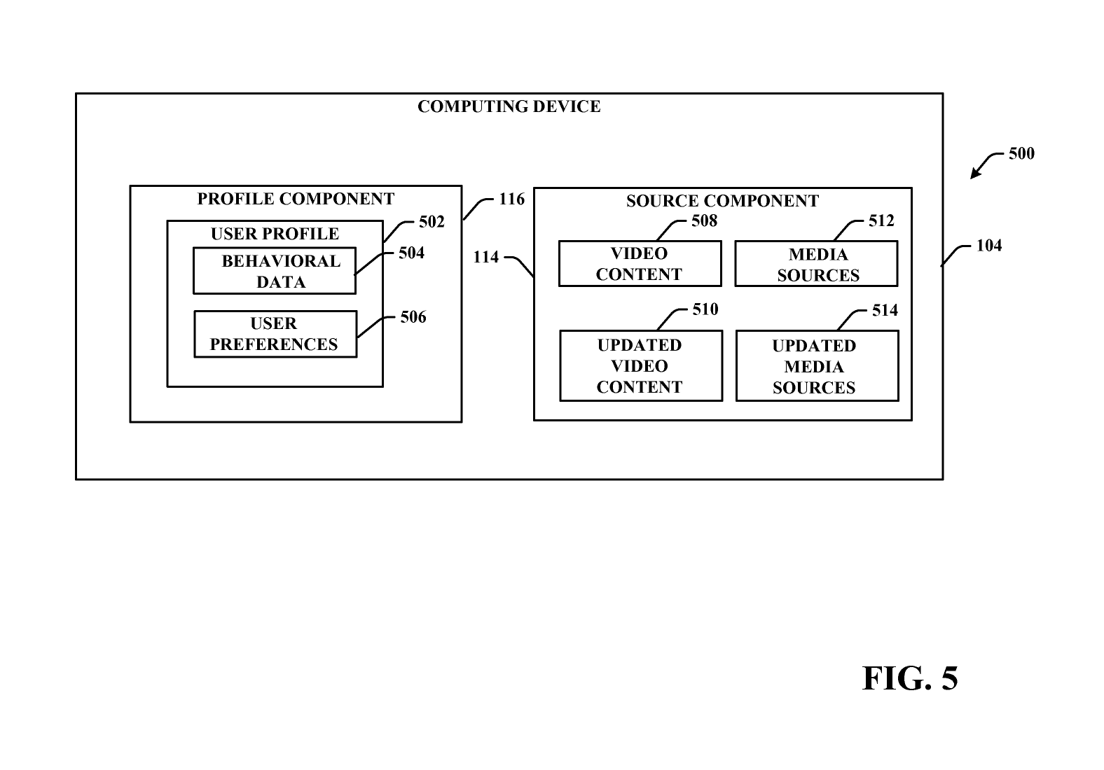

Referring now to FIG. 5, illustrated is an example system 500 in accordance with various embodiments disclosed. The system 500 includes the computing device 104 as discussed above with the source component 114 and the profile component 116 provided only for ease of discussion. The profile component 116 is communicatively coupled to a user profile 502 that comprises a set of behavioral data 504 that represents user input controls relating to the video content and the media sources, which are identified by the source component 114. The user profile 502 further comprises a set of user preferences 506.

In one embodiment, the set of behavioral data 504 comprises purchased video content related to the user profile data, viewed video content related to the user profile data, stored video content related to the user profile data, and/or search criteria for video content related to the user profile data. For example, a purchase of video content could be made with the computing device 104 or via a different device in communication with the computing device 104. The purchase can be stored as part of user profile data. The computing device 104 can utilize the purchase data along with other data learned in the user profile to recommend video content and/or media sources that are identified by the source component. The user can then opt to select a time slot, video content, and/or media source available through the recommendations provided. The personalized channel (e.g., channel 107, as discussed above) generated by the computing device can be configured with the times, content and source data according to the user's selection.

For example, a documentary on dinosaurs could be identified from a broadcast channel station (e.g., a public broadcast channel or the like) and the personalized channel be configured to transmit or communicate the documentary at the time that it is being broadcast. At the same time, a documentary similar to one that was purchased by the user could be configured to play after the dinosaur channel through a user selection of a selected content and/or media source as well. As mentioned above, the user preferences can also include viewed video content related to the user profile data, stored video content related to the user profile data, and/or search criteria for video content related to the user profile data, which can facilitate providing further recommendations, a past history record, as well as other information learned about the user's viewing habits, and/or for configuring/identifying further video content and media sources for a particular channel to be personalized at scheduled times/dates. The set of behavioral data can also include viewing data, search data, purchase data, location data, language data, age data, household membership data and/or subscription data.

In addition, the user preferences 506 can comprise a media source preference and/or a time/date preference to associate with the video content for viewing on a channel (e.g., channel 107) configured according to a user preferences and/or behavioral data related to video content. The user preferences 506 can further include a personalized channel selection where multiple channels are configured based on a user's personal preferences or classification criteria such as a theme preference, a rating preference, an actor preference, a language preference, a date preference and the like.

In one embodiment, the profile component 116 is further configured to receive a first user preference of the set of user preferences from selections related to the video content and identify a second user preference based on the set of behavioral data. For example, a personalized channel configured by the computing device for rendering different video content from different media sources at various times could recommend horror movies based on a theme preferences that a user has entered, as the user begins to override the preference and select different themes at a particular time or date, the system 500 could further recommend similar video content from differing media sources for viewing at the same time or on similar dates (e.g., weekly dates, etc.). Thus, a dynamic system 500 identifies, recommends and learns various user preferences and how they relate to one another in order to provide a dynamically configurable channel at the user's disposal.

In one embodiment, the computing device 104 is further configured to access at least one of the plurality of media sources based on the user profile data 502, such as when the user is subscribed to an online video rental site, a social network site that updates video content of friends associated with the user, as well as other web page feed services. For example, the user profile data can include access data to one or more web pages/sites, subscriptions services and/or other external video providers. This content can be presented to be configured into the personalized channel for viewing at pre-defined times or dates, as well as be used for recommendations based on other user profile data.

The source component 114 is further configured to identify updated video content 510 from among video content 508 that is different from the video content 508 previously accessed or identified as potential candidates for the personalized channel. This computer device 104 can thus communicate an updated video content selection of the updated video content 512 to the display component, and the display component is configured to generate the updated video content 510 associated with the updated video content selection in the display component via the personalized video channel in response to an updated video content selection input being received.

In addition or alternatively, the source component 114 can identified new or updated media sources 514, which could be identified from a more detailed search for media sources by the source component 114, a new broadcast or web page/site, a new subscription accessed/identified by the user profile data, and/or newly stored content in a data store or video library. A user selection could also be received for streaming via the personalized channel at particular times or dates that relates to which media source 512 or update media source 514 to render in a display or mobile device.

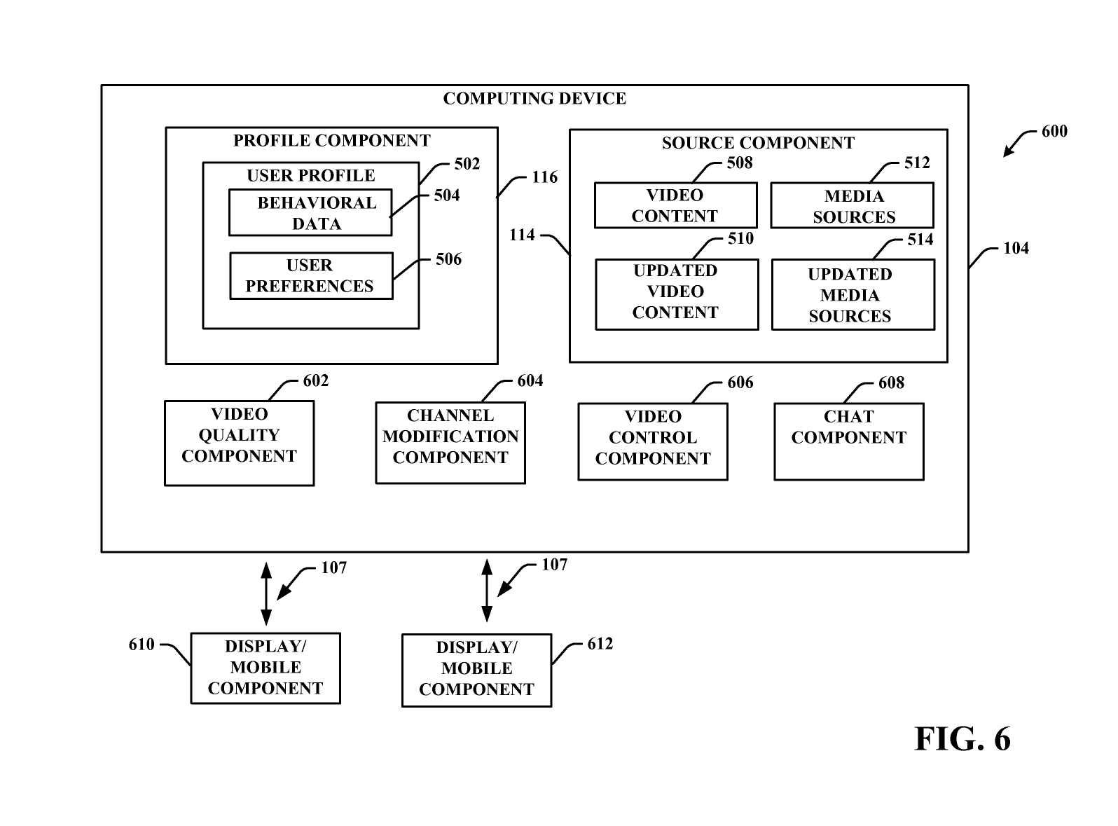

Referring to FIG. 6, illustrated is an example of a system 600 in accordance with various embodiments described herein. The computing device 104 comprises components detailed above and further comprises a video quality component 602, a channel modification component 604, a video control component 606 and a chat component 608.

The video quality component 602, for example, is configured to analyze the video content 508 and/or 510 from the media sources 512, 514 to determine a set of video characteristics comprising at least one of bitrate, frame rate, frame size, audio content, formatting, a title, an actor or actress, or metadata pertaining to the video content. The channel modification component 604 can operate in conjunction with the video quality component to configure the quality of a personalized channel. The system 600 can operate to compare duplicate video content and eliminate the duplicates that do not satisfy a predetermined threshold for quality, and thus, leave only the video content among the duplicated video content with the highest quality metrics or that is of a greater quality of service based on one of the set of video characteristics.

The channel modification component 604 is further operable to change channels that are personalized from a first personalized channel that is based on one set of user profile data and to another personalized channel that is based on another set of user profile data. In one example, the channel modification component 604 can comprise a channel control as part of the channel control component 606. The channel control component 606 can operate to alter the video content from the media sources by generating a forward, rewind, pause, skip and other graphical controls for affecting video content generated on a single personalized channel, such as channel 107. The channel control component 606 can operate to change personalized channels, which each can be configured according to a different set of user profile data 502 or a different set of user preferences 506. In addition, the video control component 606 can generate selections for altering a media source and/or a video content to be streamed over the single personalized channel 107.

In another embodiment, the video control component 606 can operate to control subscriptions to a personalized channel, such as the personalized channel 107. For example, the display component or mobile device 610 comprising a display component can facilitate the configuration data for a personalized channel 107. The display component or mobile device 610 can thus subscribe in a request to the channel 107 that is personalized by the user profile data 502 from display component 610. Therefore, two mobile devices 610, 612 can view the same content at the same time together, and/or separate at different times. In one example, selections can be received via the display component of mobile device 610 for configuring the personalized video channel for the display of mobile device 610. The selections can facilitate rendering of the video content from the media sources by receiving at least two selections, such as a video content selection, a media source selection, a topic selection, a duration selection, a title selection, a language selection, and/or a video play list/selection, a date selection, or a recommendation selection.

The chat component 608 is configured to communicate a chat screen via the personalized video channel to at least two display devices (e.g., mobile device 610, 612) receiving the video content from the plurality of media sources via the personalized video channel 107 or from different configured personalized channels associated with different user profile data, for example. The chat screen from the chat component 608 can comprise a video chat screen for generating a video chat session, and/or a text dialogue that communicates via the personalized channel 107, for example, during, before and/or after viewing video content with one or more other mobile devices. In one example, a chat overlay can be provided in which users can view the content streaming through the same personalized video channel from different devices and interact/communicate with one another.

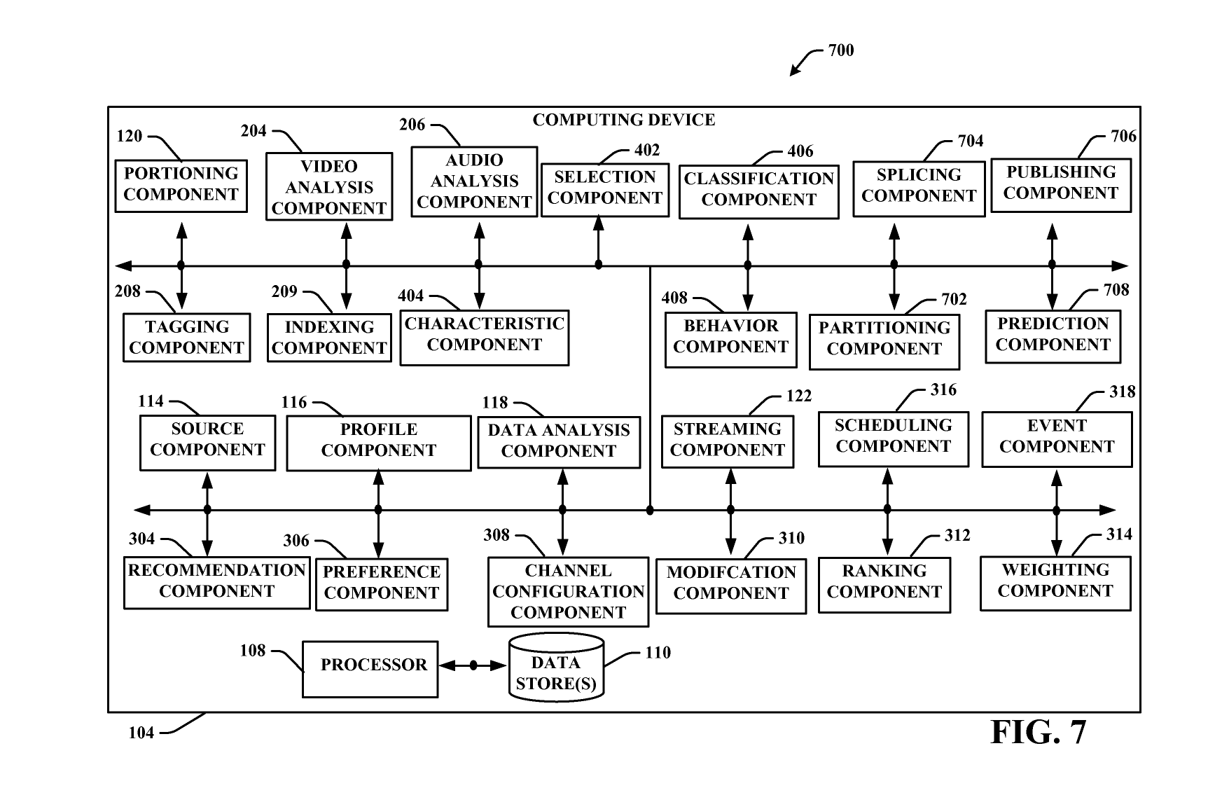

Referring now to FIG. 7, illustrated is another example system 700 for communicating predicted video content aggregated from media sources via a single personalized video channel in accordance with various embodiments described. The computer device 104 further comprises a partitioning component 702, a splicing component 704, a publishing component 706 and a prediction component 708.

The partitioning component 702 is configured to partition the video content from the plurality of media sources based on the user profile data (user preferences and/or behavioral data that represents user actions relating to video content). The partitioning component 702 operates to partition the video content of one or more media sources 102 into a plurality of video content portions (segmented partitions of programming, of videos uploaded on a web page, or of other video content) based on a defined set of criteria (e.g., the classification criteria) that comprises at least one of a topic, an audio content, a transition point in the video content, a duration or time frame, a match of the set of user preferences of the user profile data or the audio content of the video content being determined to match a word or phrase of a search term/criterion or terms/criteria of the defined set of criteria. The classification criteria can be part of the user profile data such as part of user preferences as a category for video classification preferences.

In one embodiment, the partitioning component 702 operates to partition video content into segments or subsets of the programmed content based on criteria defined as part of the user profile data. The portions or segments can be part of a video content as defined by a time frame, an end time, a title, and/or other defining or classifying criteria. For example, a portion of video content can be a section, segment or portion of a news broadcast, in which a certain topic could be discussed relating to a hurricane in New Orleans, while the entire news broadcast could be a designated hour long having multiple different segments related to different news topics or stories.

The streaming component 122 is thus operable to communicate a sequence of the video content from the plurality of media sources, as well as communicate various media content portions based on user profile data (user preferences, classification criteria, and/or behavioral data), ranks and weights associated with the content and also from different media sources at different times. For example, the streaming component 122 is configured to communicate an updated video content selection (e.g., a new episode, a new video from an identified friend on a social network, an updated of a social network news feed, a broadcast content programming at a certain time, title, or other related criteria data) as well as portions of each based on classification criteria and the partitions generated from the partitioning component 702. The personalized video channel 107 can be configured to render the content to a display (e.g., a touch screen panel display or the like) and generate the updated video content associated with the updated video content selection in the display component in response to an updated video content selection input being received.

The splicing component 704 is configured to identify a portion or segment of a programming within the video content of a corresponding media source and extract the portion of the programming based on user profile data. The splicing component 704 can operate as a separate component from the partitioning component 702 and/or as a complimentary component of the partitioning component 702. While the splicing component 704 can operate to generate portions of video content segments or subsets of defined sets of video content, the partitioning component 702 can operate to generate the video content segments, or, otherwise known as, video content (video(s)) from different media sources. Some media sources, for example, such as a social network site could provide data indicating that a video upload or updated video content has occurred for one or more friends within a user's network. These videos could corresponding to different full length videos, which could range from a few minutes to hours, or more in duration, but have a defined beginning and ending point. However, broadcast television programming could have continuous video streaming that could be recorded and communicated via the personalized video channels 302 and/or 107, and/or communicated at the time of broadcast. The partitioning component 702 can operate to divide the different programming and video content identified among various channels, such as channel 302 and 107 based on user profile data, and/or divide broadcast programming to different channels as well as for different times, in which programming from one local broadcast could be streamed and then another local broadcast of a different station could be streamed thereafter without the user having to change a channel as in traditional methods.

The splicing component 704 can generate portions of segmented video content or of full length content that is not continuously broadcasted. For example, a new station could report, broadcast and/or upload a news hour broadcast. The different portions or stories could be dynamically spliced based on user profile data, such as search data. The portions can be presented to the user dynamically as options and then played to the client component 304 and/or 308 based on the user profile data and/or selections to the options.

The computing device 104 is operable to publish components via the publishing component 706 to the network 202, from the network 202 and/or via the network 202 for implementation of the operations of the computing device 104 at one or more client components or mobile devices. The publishing component 706 can operate to publish personalized configuration channel(s) 107 for subscription to or viewing by other mobile devices other than the mobile device authorized for configuring the channel with various video content, scheduled times and media source(s).

The publishing component 706 can operate to control what mobile devices, networks, and/or web feeds are provided content via the personalized video channel 107, for example. The video content could be generated, for example, from a personal data store of family videos, as well as from various other broadcasting media, web pages, web feeds, and the like media sources. The video content could then be published to a social network for friends and family, and/or for one or more viewing devices for friends and family connected to the mobile device 210 via the network 202 for viewing content associated with the particular mobile device's user preferences, for example. Videos of family, grandchildren, etc. could then be followed up with and/or subscribed to at various predetermined times. Consequently, grandparents could follow the growth of grandchildren and events published via the family personal channel before calling each week to their children, while also watching similar content via the same personalized channel for sake of conversation, or further interest.

In one embodiment, a user via the mobile device 212, as discussed above, is operable to configure the channel 107 as having a first set of video content from a first set of media sources (e.g., set of MTV videos, Facebook news feeds, chat/video conference screen, and the Grammy awards) and a different communication channel 107 via a second different set of video content from different media sources by manually setting the content and/or managing the user profile data for settings, classifications/classification criteria, and/or behavioral data representing user input controls related to video input. The user profile data could be entered or learned to provide the Grammy awards via the personalized channel 107 at the same time as to mobile device 314 for viewing on, and thus, the channel 107 could alternatively or additionally be shared to mobile device 210. The publishing component 706 is operable to publish a channel, such as the personalized channel 107 for any connected viewer from the same set of user profile data or from a different set of user profile data that has been enabled for access. For example, a request could be received by one viewer or one mobile device to another for accessing a personalized channel that is configured by the mobile device that is in control of personalizing or configuring the particular personalized channel. The publishing component 706 operates to communicate to the requesting mobile device the personalized channel (e.g., channel 107) upon acceptance of the request by the configuring mobile device (e.g., mobile device 210). One or more devices are able to access a personalized channel with personalized content and from a selected media source at any given time while also utilizing resources to share the personalized experience, such as with video chat, chat component, searching capabilities, suggestions, rating, personal content viewing, and/or personal commercial marketing intermittently with configured programming from different media sources and/or personal video content at the data store(s) 110.

In one example, the personalized channel 107 can be configured by the mobile device 3210 for viewing at the mobile device 210 and also for the mobile device 212 with programming from one wired broadcast and of another wireless broadcast thereafter, and regardless of the different media sources and their sequential video content via the personal video channel 107, family videos in a data store of the mobile device 210 could be streamed intermittently, and/or other video content from a personal data base in communication with the mobile device 210. In another embodiment, control of the personalized channel and the configuration of the channel can be dynamic and be altered by the user profile data of the mobile device that is configuring the personal communication channel, such as with a password or other security. The mobile device 210 could alter the viewing of the Grammy Awards via the channel 107, therefore, to provide content from MTV videos playing different content, either at different times, intermittently, and/or at sequential times before and/or following the Grammy Awards. For example, while two devices 210, 212 are viewing the Grammy Awards, the mobile device 210 could alter the media source and/or viewing content to demonstrate, supplement, or change the main viewing to other video content. Both mobile devices could decide together that one type of video content is undesirable (e.g., boring) so a chat screen could be published via the publishing component 706 and utilized to indicate the desire to switch to another on the personalized channel. The mobile device in control of the configuration could opt to draw from an online video rental, other broadcast channel, a Facebook feed, etc., in which the two mobile devices would more enjoy with one another and on different mobile devices.

The computing device 104 operates further to predict video content and associated media sources for a personalized video channel 107 to communicate based on user profile data. The prediction component 708 operates to analyze user profile data aggregated by the profile component 116 and to communicate video content via the personalized channel 107 based on the predicted content. For example, in situations where no scheduled viewing is configured to the personalized channel 107, the prediction component 708 can analyze, store, and communicate updated content via the personalized channel 107, which depends on the user profile data for such prediction.

The prediction component 708 is configured to generate a set of predicted video content from the plurality of media sources based on the user profile data. In one embodiment, the video channel 107 can be configured with predicted video content at times along a time axis. A user is able to view predicted content by default by enabling transmission of video content to be viewed at a user device via the personalized video channel 107 at any time. Further, scheduled times can be defined by the user to alter the predicted content and override any defaults of the system through one or more user controls of a prediction grid. The personalized video channel 107 is utilized for viewing with predicted content as a default to eliminate normal changing and searching video content/media sources by the user and could also be for regular viewing by other users of other devices that are part of the users group of friends, family or accepted viewers. For example, the user profile data could comprise information that a user of a mobile phone that is in primary control of the configuration of the channel 107 views reality shows (e.g., Pawn Stars, Swamp People, Gold Rush, etc.) at a particular time (e.g., before a night time). In a situation where the user views his/her personalized channel 107, even though the channel is not configured for a certain date or time, the system could communicate learned likes and dislikes for the particular time and either communicate reality show options and/or select a best option by which to stream video content via the channel 107 to the user along with any other recommended options for viewing aside from the predicted content being communicated.

For example, the prediction component 708 operates to predict/identify video content from among multiple identified media sources as what the user wants to view at each moment in a day time and/or each day of a calendar day (a week/month/year), such as what a user would have watched an hour ago or other past point in time, and what the user would view as video content from a corresponding media sources at a present point of time. The prediction component 708 operates therefore to predict the video content and media sources, to enable a user to select any point of time and any of the predicted video content/media sources at the point of time selected (past, present, future points of time), and to configure the personalized video channel with a predicted video content from the selected point of time.

In one example, the prediction component 708 can know that at 9 AM the user is watching her child's cartoons while gathering her daughter to school. Then she operates the personalized viewing channel 107 on again at 10 AM after she returns from dropping her child at school and that at this time she like to watch political news. But today, her kid fell ill and did not go to kindergarten. The system 100 could know via a user device, display component, mobile device, etc. that she ran to see the doctor and returned home to stay in bed. As such, when the user tunes into the personalized viewing channel 107 at 10 and, instead of following past recommendations for her to watch her usual new show she can requests to display recommendations of 9 AM spot, when the kids shows are historically predicted/recommended. The same cartoons/video content that would have been displayed at the 9 AM spot could be generated via the personalized video channel 107 and/or different content based on storage and availability. In addition or alternatively, the same classification of video content could be generated based on one or more classification criteria (e.g., cartoons at 10 AM).

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases. Reference may be made to the figures described above for ease of description. However, the methods are not limited to any particular embodiment or example provided within this disclosure and can be applied to any of the systems disclosed herein.

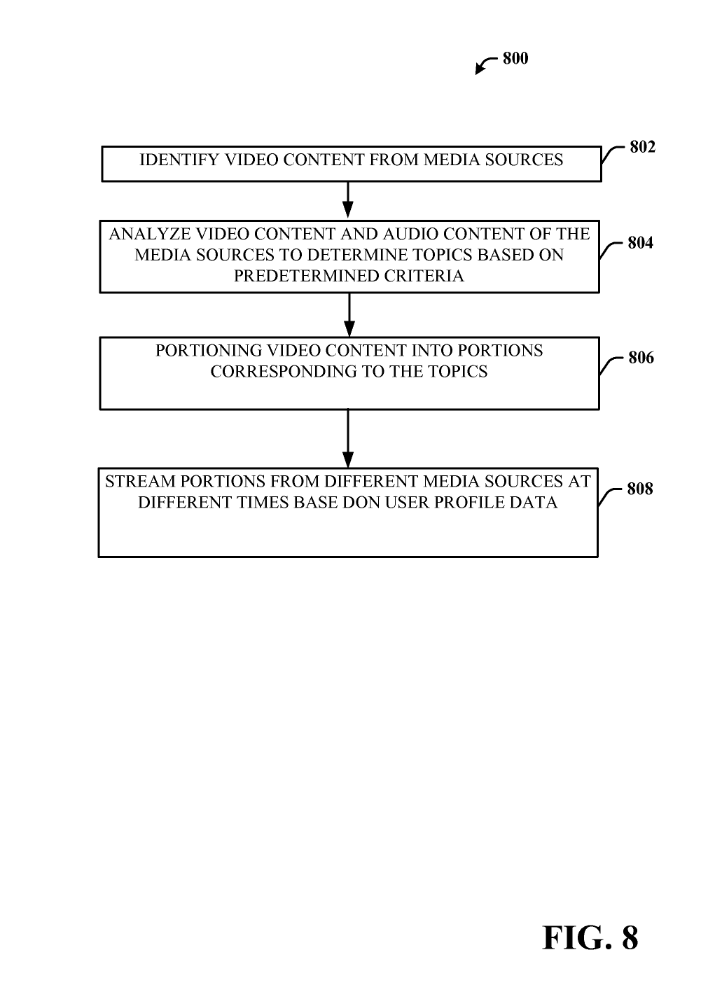

Referring to FIG. 8, illustrated is an exemplary system flow 800 in accordance with embodiments described in this disclosure. The method 800 initiates at 802 identifying, by a system comprising at least one processor, a video content from media sources that comprise at least two of a broadcast media channel, a web page, a web data feed, a network subscription service or a video library for communicating the video content via a personalized video channel. At 804, the video content and audio content of the media sources are analyzed to determine a plurality of topics based on a set of predetermined criteria. The set of predetermined criteria can comprise, for example, a topic of the plurality of topics and at least one of a transition point in the video content, a duration, a match of the set of user preferences or the audio content of the video content being determined to match a word or a phrase of a search criterion of the set of user preferences. At 806, the video content is portioned or segmented into portions of the video content corresponding to the plurality of topics. For example, the topics can correspond to transitions or boundaries within the audio and video content, in which the video content portions can be identified. At 808, the portions can be streamed from different media sources of the media sources at different times based on a set of user preferences comprising the plurality of topics via the personalized video channel.

In one embodiment, the method 800 can include comparing video content from the media sources to identify duplicate video content, removing the duplicate video content from a set of video content selections to be viewed via the personalized video channel, and maintaining the video content having greater characteristic values of the set of video characteristics than the duplicate video content. The video characteristics can comprise at least one of bitrate, frame rate, frame size, audio content, formatting, a title, an actor or actress, and/or metadata pertaining to the video content.

The method 800 can further include identifying a video transition of the video content of a media source of the media sources based on a set of video criteria comprising at least one of a difference in a scene setting, a change in one or more characters, a change in view settings, a difference threshold in frames being satisfied and/or a difference threshold in objects recognized. The transitions or boundary transitions can be further identified according to an audio transition of the video content of the media sources based on a set of audio criteria comprising at least one of a word or a phrase that matches a topic of the plurality of topics, at least one of a change in vocal tone, a change in voice, and/or a change in a frequency of detection with respect to time of the plurality of topics from the video content of the media sources.

In another embodiment, a tag having metadata can be associated to the portions of the video content respectively from the media sources. The metadata can comprise at least one of a time of the video content from a corresponding media source of the media sources, a location comprising a city or region, a device type for compatibility, and/or a top tier of video content having a rank that satisfies a predetermined rank threshold based on a frequency of detection of a topic of the plurality of topics. The portions of the video content can be indexed according to a word or a phrase spoken within the portions, and associating the portions of the video content with a set of classifications. The tags can be indexed that correspond to the portions and/or the portions themselves. The set of classifications can include or be based on, for example, at least one of a set of themes, a set of media ratings, a set of actors, a set of song artists, a set of album titles, and/or a set of date ranges.

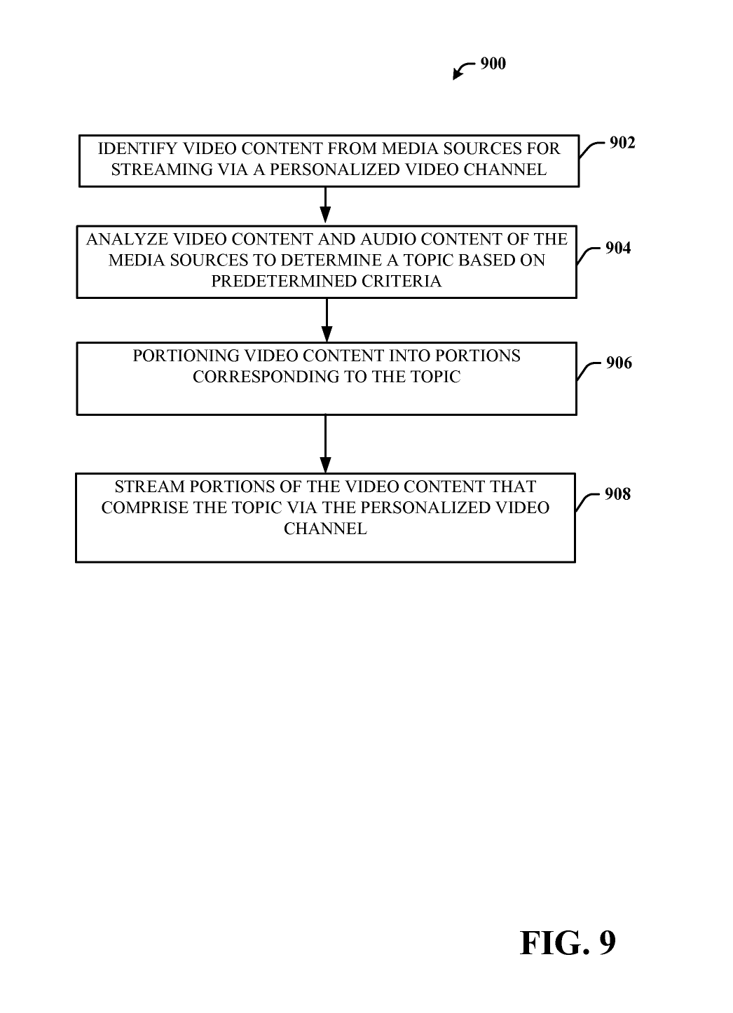

Referring to FIG. 9, illustrated is an exemplary system flow 900 in accordance with embodiments described in this disclosure. The method 900 initiates at 902 identifying, by a system comprising at least one processor, a video content from media sources streaming the video content via a personalized video channel. At 904, the method analyzing the video content and associated audio content of the video content from the media sources to determine a topic based on a set of predetermined criteria. The set of predetermined criteria comprise a set of user preferences including the topic, at least one of a media source preference, a time preference to associate with the video content, a personalized channel selection, a theme preference, a rating preference, an actor preference, a language preference or a date preference.

At 906, the video content is portioned into portions corresponding to the topic. At 908, the portions of the video content that include the topic are streamed from the media sources via the personalized video channel. The media sources can comprise at least two of a broadcast media channel, a web page, a web data feed, a network subscription service or a video library for communicating the video content via the personalized video channel.

In one embodiment, the method 900 includes associating a tag having metadata to the portions of the video content respectively from the media sources. The metadata can comprise at least one of a time of the video content from a corresponding media source of the media sources, a location comprising a city or region, a device type for compatibility, or a rank that satisfies a predetermined rank threshold based on a frequency of detection of the topic. The portions of the video content and/or the tags associated with the portions can be indexed. The portions and/or tags can be categorized and indexed according to a word or a phrase spoken within the portions as well as according to the user profile data, such as the preferences for particular content.

For example, the portions can be communicated as a set of selections to respectively schedule at different times in a display component for rendering the portions at the different times via the personalized video channel. The set of predetermined criteria can comprise a set of user preferences including the topic, at least one of a media source preference, a time preference to associate with the video content, a personalized channel selection, a theme preference, a rating preference, an actor preference, a language preference or a date preference. Further, the media sources can comprise at least one of a broadcast media channel, a web page, a web data feed, a network subscription service or a video library for communicating the video content via the personalized video channel. Also optionally, the video content can be classified according to a set of classifications based on at least one of a set of themes, a set of media ratings, a set of actors, a set of song artists, a set of album titles, or a set of date ranges.

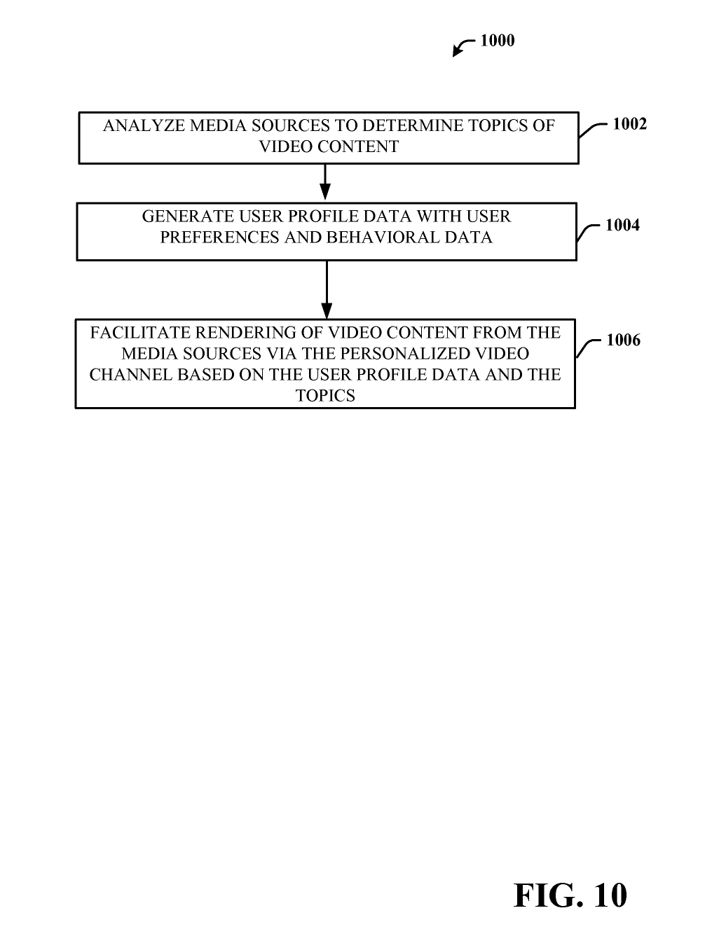

Referring to FIG. 10, illustrated is an exemplary system flow 1000 in accordance with embodiments described in this disclosure. The method 1000 initiates at 1002 with analyzing, by a system comprising a processor, media sources to determine topics for generating video content via a personalized video channel. At 1004, user profile data is generated by being received by a user and/or learning information related to the user via profile information, classification criteria settings, and behavioral data. The user profile data is based on a set of user preferences for the video content as well as a set of behavioral data representing user control inputs related to the video content, for example. The control inputs can include purchasing, viewing, rewinding, skipping, canceling, sharing and/or searching for video content and media content sources, for example.

At 1006, the video content is rendered from the media sources via the personalized video channel based on the user profile data and the plurality of topics determined from the video content. For example, the video content can be communicated via the personalized video channel corresponding to the plurality of topics based on a frequency of detection within the video content of the media sources. Time slots can be generated corresponding to the plurality of topics of the video content in order for scheduling of content and time stamping video content for scheduling. The video content can be classified based on a category that includes a news broadcast, a movie, a branded channel, and/or a television series and at least one of a genre, a media content rating, a performer, a location or region, and/or a title. The video content can be weighted at different times with a weight measure respectively based on the user profile data, the ranking and the category.

The video content of the media sources can be queued in a data store or in a queue based on the weight measure respectively to configure the personalized video channel to communicate the video content according to the queue. For example, the queue can be first in first out queue and/or other kind of queue for video content to be streamed via the personalized video channel. In another example, the weight measure can be altered based on a change of the user profile data, the ranking and/or the classification or category of the video content.

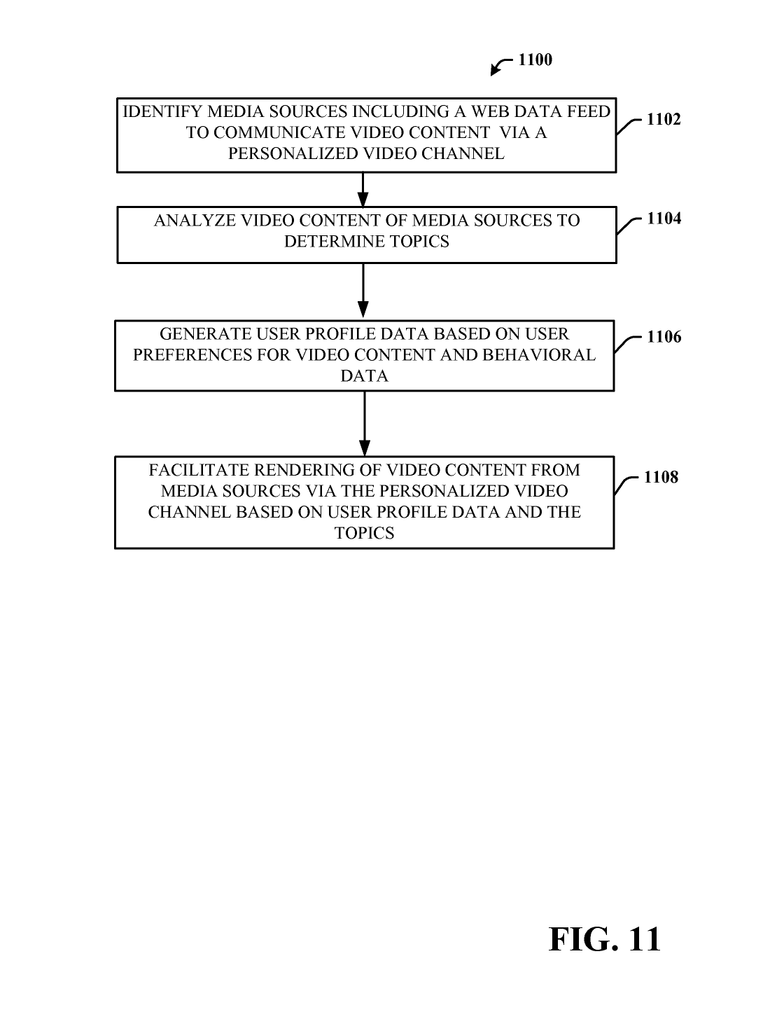

Referring to FIG. 11, illustrated is an exemplary system flow 1100 in accordance with embodiments described in this disclosure. The method 1100 initiates at 1102 with identifying a plurality of media sources comprising a web data feed to communicate video content from the web data feed via a personalized video channel. Additionally or alternatively, the media sources can include a wireless broadcast media channel, a web site, a network subscription or a wired broadcast channel for communication via the personalized video channel. At 1104, the method continues with analyzing the video content of the plurality of media sources to determine a plurality of topics. At 1106, user profile data that is based on a set of user preferences related to the video content is generated and/or received. At 1108, the video content is communicated via the personalized video channel based on the plurality of topics and the user profile data.

In one embodiment, ranks are generated corresponding to the plurality of topics based on a frequency of detection within the video content of the media sources. The video content can be weighted according to or at different times for scheduling with a weight measure respectively based on the user profile data, the ranks and the classification criterion. The video content of the media sources is then stored in a queue based on the weight measure respectively to configure the personalized video channel to communicate the video content according to the queue, and the video content is scheduled according to scheduled time slots and the ranks.

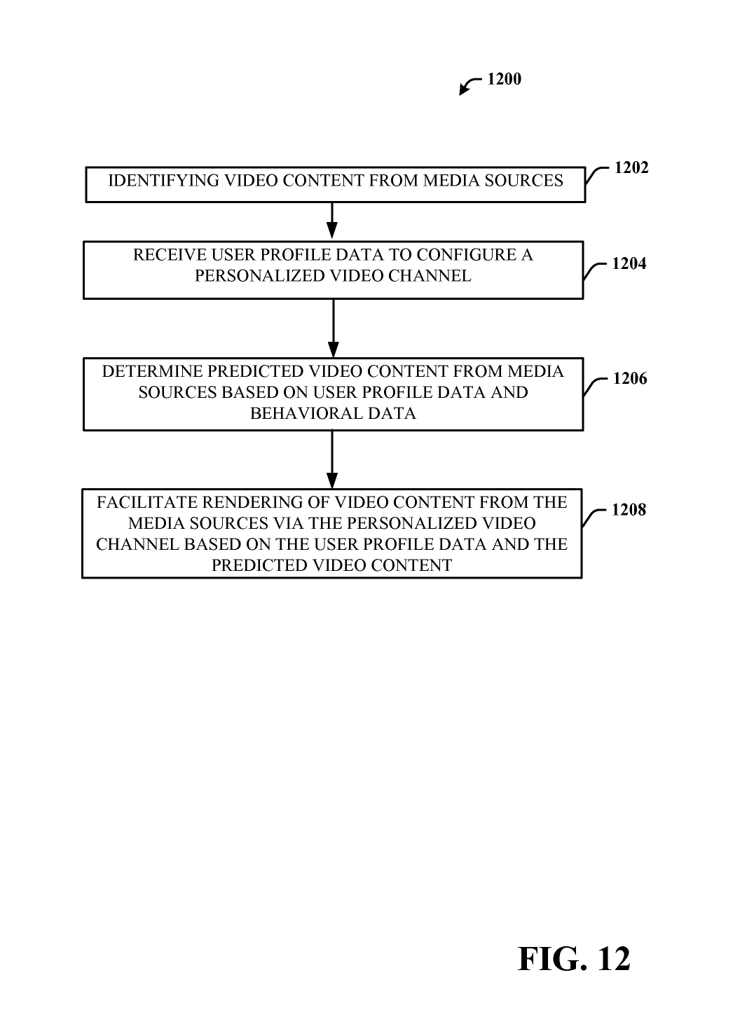

Referring to FIG. 12, illustrated is an exemplary system flow 1200 in accordance with embodiments described in this disclosure. The method 1200 initiates at 1202 with identifying, by a system comprising at least one processor, video content from media sources for communication of the video content via a personalized video channel. At 1204, user profile data is received or determined to configure the personalized video channel according to a time, the video content and the media sources of the video content. At 1206, a set of predicted video content is determined from the media sources based on user profile data that comprises user preferences and a set of behavioral data representing user control inputs received for the video content. At 1208, a rendering of the video content is from the media sources is facilitated via the personalized video channel in a display component based on the user profile data and the set of predicted video content, such as a selection for the predicted content from the prediction component and/or a user input control selection from among options presented.

The media sources can comprise at least two of a broadcast media channel, a web page, a web data feed, a network subscription service or a video library with personalized video content, such as home/personal videos with a recording device. The personalized video channel is able to be modified by a user with a second video content from a second media source to replace a first video content from a first media source at a designated or scheduled times. For example, the user preferences can comprises a time preference, a date preference, a video content preference, a media source preference or a video portion preference that corresponds to the video content from the media sources.

In one embodiment, the method can include receiving a request from a first mobile device to receive the personalized video channel at the first mobile device. The second mobile device that can be authorized to configure the personalized video channel for different media sources and/or video content identified can generate an acceptance for the first second mobile device. The system can then receive the acceptance and publish the personalized video channel to the first mobile device.

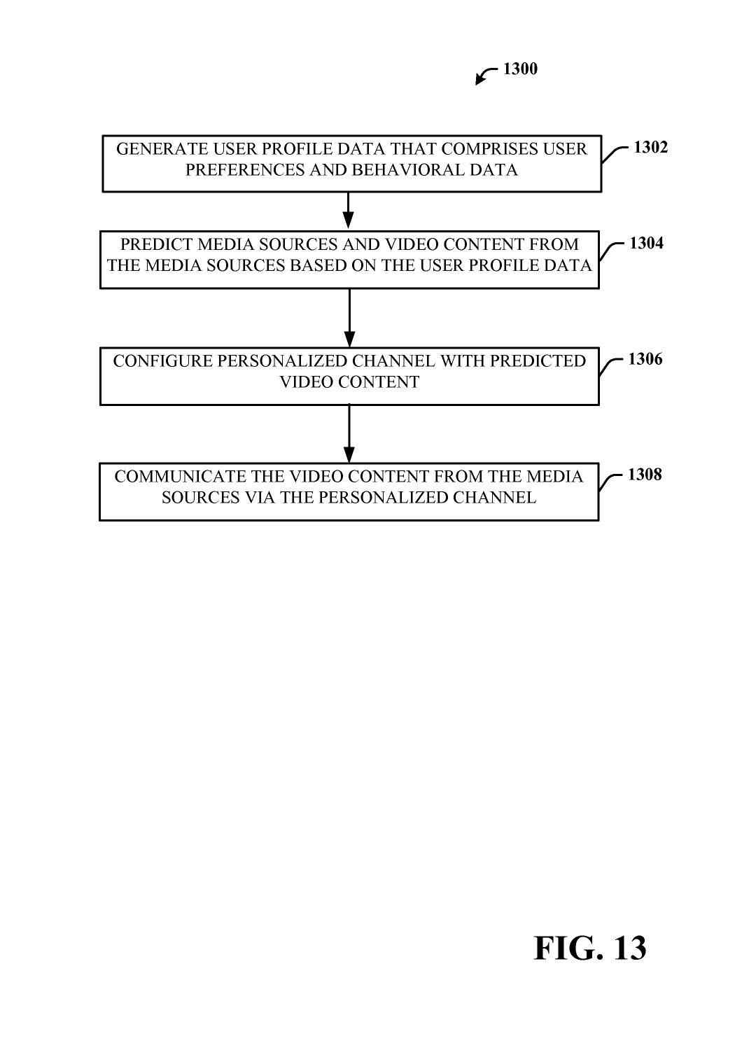

Referring to FIG. 13, illustrated is an exemplary system flow 1300 in accordance with embodiments described in this disclosure. The method 1300 initiates at 1302 and generates user profile data comprising user preferences and behavioral data representing user control inputs associated with a personalized channel to be rendered by a mobile device. At 1304, media sources and video content communicated from the media sources are predicted based on the user profile data for a viewer or a user of the mobile device. At 1306, the personalized channel is configured with the predicted video content from the media sources at different times based on the user profile data and the predicted media sources. At 1308, the video content is communicated from the media sources via the personalized channel for rendering by the mobile device.

In one embodiment, the method 1300 can further comprise generating a prediction grid that communicates the video content based on the user profile data. The video content predicted is corresponded or associated to a set of points in time along a time line based on metadata associated with the video content and identification of the media sources of the video content for a selected point of the set of points. A prediction grid can also be communicated via the personalized channel to the mobile device, in which the prediction grid comprises a past point of time, a present point of time and a future point of time of the set of points that indicates the video content predicted at the selected point depending on a set of criteria that comprises at least one of user profile data stored at the present point of time, or user profile data stored at the selected point along the time line. The user preferences can further include a classification criterion that comprises at least one of a theme, an age range, a media content rating, an actor or actress, or a title, represented in the user profile data.

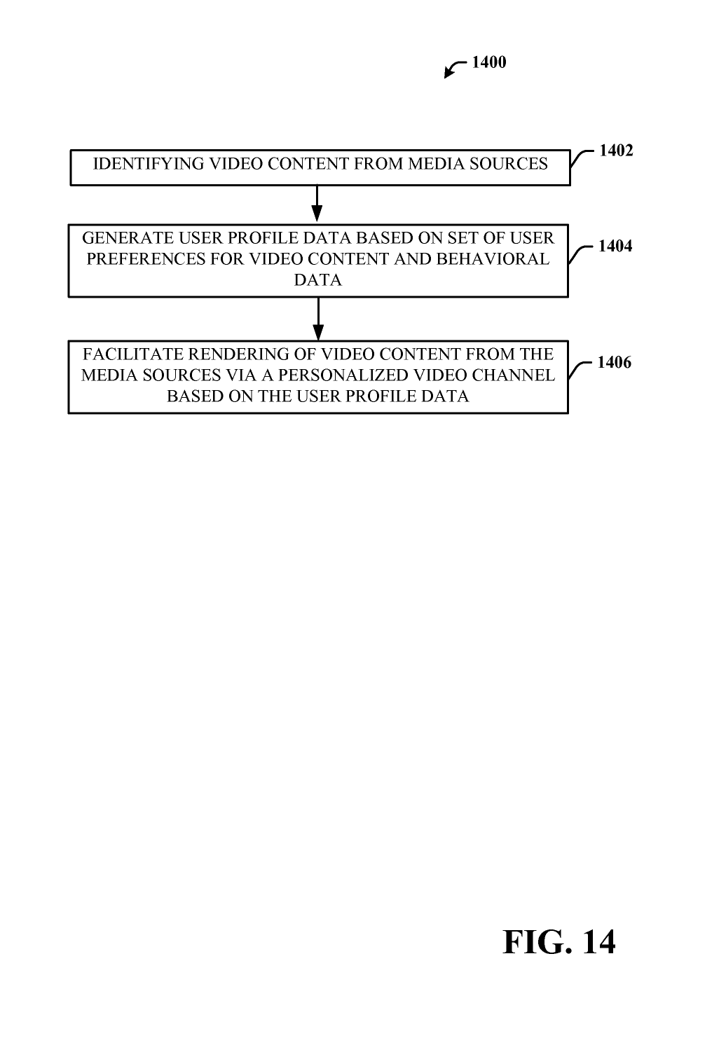

Referring to FIG. 14, illustrated is an exemplary system flow 1400 in accordance with embodiments described in this disclosure. The method 1400 identifies, by a system comprising at least one processor, video content at 1402 from media sources for generating, or communicating, the video content via a personalized video channel. For example, the media sources can comprise at least two of a broadcast media channel, a web page/site, and a web data feed, a network subscription service, a social network feed, and/or a video library and the like. At 1404, user profile data is generated based on a set of user preferences for the video content and a set of behavioral data that represents user control inputs related to the video content. The user preferences could be a genre, an audio word or phrase within the content, a title, a language spoken, an actor/actress present, a time/date for rendering via the personalized channel, and the like. The user preferences can include a classification criterion, for example, that comprises at least one of a theme, an age range, a media content rating, an actor or actress, a title, which is associated with the video content, and whether audio content of a video content portion matches a word or phrase of a search criteria represented in the user profile data.

The behavioral data can include activities of the user for determining what the user could be interested in, such as purchases made of video content, search terms or criteria for video content, activities during viewing of video content (e.g., skipping content, fast forwarding, etc.), and any control input to video content in response to rendering the video content via a personalized channel.

At 1406, a rendering of the video content is facilitated from the media sources by a display component via the personalized video channel based on the user profile data. The channel is personalized for rendering content from various sources at different times and operable to interact with the content through sharing, publishing to other devices, rendering in a view pane, further configuration (e.g., altering source during a particular time, modifying the video content form a particular source, etc.). In addition or alternatively, a personalized channel selection can be received as profile data that determines whether the video content of a first personalized video channel or a different video content of a second personalized video channel is sent to the display component for rendering in a display component for viewing.

In one embodiment, the method can include comparing the video content from the media sources to identify duplicate video content, and removing the duplicate video content from a set of video content selections, in order to provide video content and/or media sources of the respective content as selections for configuring the personalized channel based on user profile data. The removal of duplicates could be according to one or more criteria, such as bit rate, resolution and/or other video quality criteria for maintaining the video content having a greater quality of service than the duplicate video content. For example, the method could include analyzing the video content from the media sources to determine one or more video characteristics, such as bitrate, frame rate, frame size, audio content, formatting, a title, an actor and/or actress, and/or metadata pertaining to the video content. The analysis of video content can operate to enable further removal of duplicate video content.

In another embodiment, the method 1400 can further include partitioning of the video content into a plurality of video content portions based on a defined set of criteria that comprises at least one of a topic, an audio content, a transition point in the video content, a duration or time frame, a match of the set of user preferences of the user profile data or the audio content of the video content being determined to match a word or phrase of a search criterion of the defined set of criteria. The portions can include, for example, various programming sequences being broadcast from one or more of the media sources, and/or of entire video content, in which the portions are splices of subsets of the video content in order to facilitate rendering of only interesting sections according to user profile data.

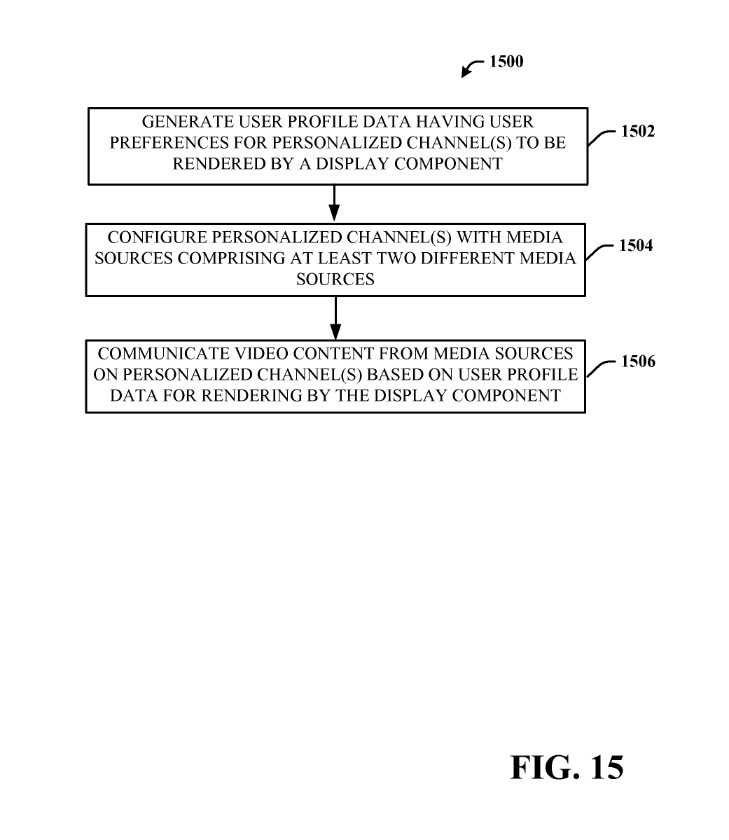

Referring to FIG. 15, illustrated is an exemplary system flow 1500 in accordance with embodiments described in this disclosure. The method 1500 generates user profile data having a set of user preferences for a set of personalized channels to be rendered by a display component. At 1504, the set of personalized channels is configured with media sources comprising at least two of a broadcast channel, a news data feed, a social data feed, a web site, a subscription broadcast service, a personal data store and/or the like. At 1506, video content is communicated from the media sources on the set of personalized channels based on the user profile data for rendering by the display component.

In one embodiment, configuring the set of personalized channels can include associating metadata with the video content or with at least one of the media sources from which the video content originate. The metadata can include information about the video content, a media source, and/or channel data (e.g., timing, scheduling, titles, etc.), in which the data can be associated from user preferences of the user profile data and/or manually associated with the video content and/or the media source. In addition, additional media sources can be added to the set of personalized channels as additional sources available are identified.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

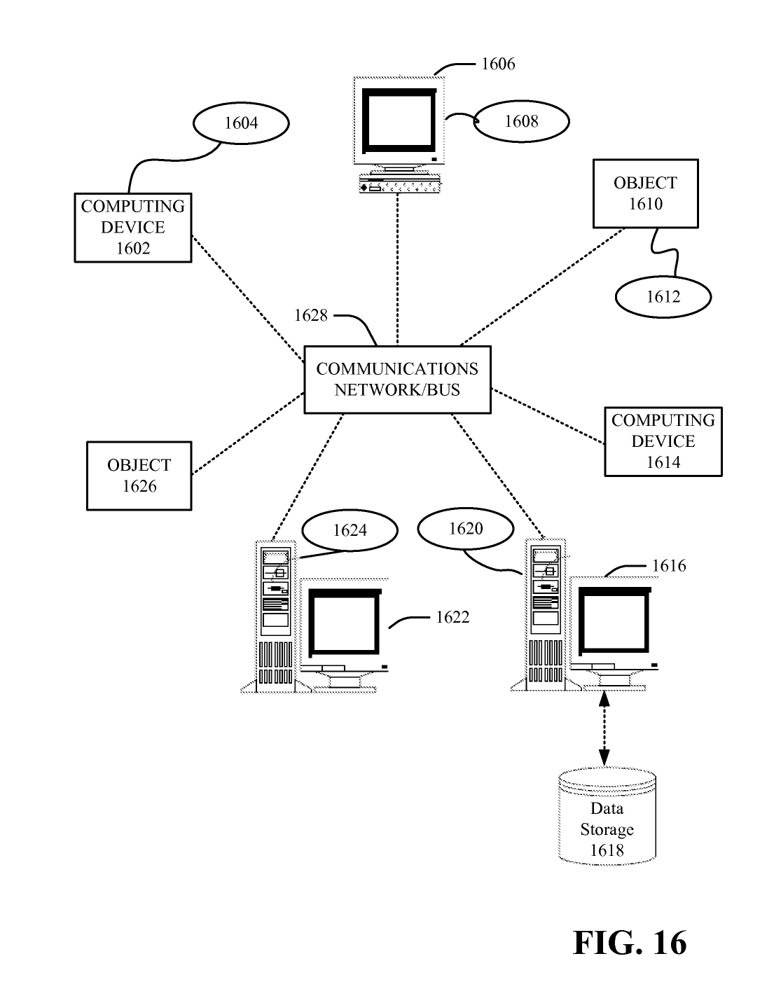

FIG. 16 provides a schematic diagram of an exemplary networked or distributed computing environment. The distributed computing environment comprises computing objects 1610, 1626, etc. and computing objects or devices 1602, 1606, 1610, 1614, etc., which may include programs, methods, data stores, programmable logic, etc., as represented by applications 1604, 1608, 1612, 1620, 1624. It can be appreciated that computing objects 1612, 1626, etc. and computing objects or devices 1602, 1606, 1610, 1614, etc. may comprise different devices, such as personal digital assistants (PDAs), audio/video devices, mobile phones, MP3 players, personal computers, laptops, etc.

Each computing object 1610, 1612, etc. and computing objects or devices 1620, 1622, 1624, 1626, etc. can communicate with one or more other computing objects 1610, 1612, etc. and computing objects or devices 1620, 1622, 1624, 1626, etc. by way of the communications network 1628, either directly or indirectly. Even though illustrated as a single element in FIG. 16, communications network 1628 may comprise other computing objects and computing devices that provide services to the system of FIG. 16, and/or may represent multiple interconnected networks, which are not shown. Each computing object 1610, 1626, etc. or computing object or device 1620, 1622, 1624, 1626, etc. can also contain an application, such as applications 1604, 1608, 1612, 1620, 1624, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 16, as a non-limiting example, computing objects or devices 1620, 1622, 1624, 1626, etc. can be thought of as clients and computing objects 1610, 1626, etc. can be thought of as servers where computing objects 1610, 1626, etc., acting as servers provide data services, such as receiving data from client computing objects or devices 1620, 1622, 1624, 1626, etc., storing of data, processing of data, transmitting data to client computing objects or devices 1620, 1622, 1624, 1626, 1628, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1640 or bus is the Internet, for example, the computing objects 1610, 1626, etc. can be Web servers with which other computing objects or devices 1620, 1622, 1624, 1626, etc. communicate via any of a number of known protocols, such as the hypertext transfer protocol (HTTP). Computing objects 1610, 1612, etc. acting as servers may also serve as clients, e.g., computing objects or devices 1620, 1622, 1624, 1626, etc., as may be characteristic of a distributed computing environment.

### Example Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 17 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 17 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 17 illustrates an example of a system 1710 comprising a computing device 1712 configured to implement one or more embodiments provided herein. In one configuration, computing device 1712 includes at least one processing unit 1716 and memory 1718. Depending on the exact configuration and type of computing device, memory 1718 may be volatile (such as RAM, for example), non-volatile (such as ROM, flash memory, etc., for example) or some combination of the two. This configuration is illustrated in FIG. 17 by dashed line 1714.

In other embodiments, device 1712 may include additional features and/or functionality. For example, device 1712 may also include additional storage (e.g., removable and/or non-removable) including, but not limited to, magnetic storage, optical storage, and the like. Such additional storage is illustrated in FIG. 17 by storage 1720. In one embodiment, computer readable instructions to implement one or more embodiments provided herein may be in storage 1720. Storage 1720 may also store other computer readable instructions to implement an operating system, an application program, and the like. Computer readable instructions may be loaded in memory 1718 for execution by processing unit 1716, for example.

The term “computer readable media” as used herein includes computer storage media. Computer storage media includes volatile and nonvolatile, removable and non-removable media implemented in any method or technology for storage of information such as computer readable instructions or other data. Memory 1718 and storage 1720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1712. Any such computer storage media may be part of device 1712.

Device 1712 may also include communication connection(s) 1726 that allows device 1712 to communicate with other devices. Communication connection(s) 1726 may include, but is not limited to, a modem, a Network Interface Card (NIC), an integrated network interface, a radio frequency transmitter/receiver, an infrared port, a USB connection, or other interfaces for connecting computing device 1712 to other computing devices. Communication connection(s) 1726 may include a wired connection or a wireless connection. Communication connection(s) 1726 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1718 and storage 1720 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1712. Any such computer readable storage media may be part of device 1712.

Device 1712 may also include communication connection(s) 1726 that allows device 1712 to communicate with other devices. Communication connection(s) 1726 may include, but is not limited to, a modem, a Network Interface Card (NIC), an integrated network interface, a radio frequency transmitter/receiver, an infrared port, a USB connection, or other interfaces for connecting computing device 1712 to other computing devices. Communication connection(s) 1726 may include a wired connection or a wireless connection. Communication connection(s) 1726 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1712 may include input device(s) 1724 such as keyboard, mouse, pen, voice input device, touch input device, infrared cameras, video input devices, and/or any other input device. Output device(s) 1722 such as one or more displays, speakers, printers, and/or any other output device may also be included in device 1712. Input device(s) 1724 and output device(s) 1722 may be connected to device 1712 via a wired connection, wireless connection, or any combination thereof. In one embodiment, an input device or an output device from another computing device may be used as input device(s) 1724 or output device(s) 1722 for computing device 1712.

Components of computing device 1712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1712 may be interconnected by a network. For example, memory 1718 may be comprised of multiple physical memory units located in different physical locations interconnected by a network.

Those skilled in the art will realize that storage devices utilized to store computer readable instructions may be distributed across a network. For example, a computing device 1730 accessible via network 1728 may store computer readable instructions to implement one or more embodiments provided herein. Computing device 1712 may access computing device 1730 and download a part or all of the computer readable instructions for execution. Alternatively, computing device 1712 may download pieces of the computer readable instructions, as needed, or some instructions may be executed at computing device 1712 and some at computing device 1730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components; and
a processor, communicatively coupled to the memory, that facilitates execution of the computer-executable components, the computer-executable components comprising:
a source component configured to identify video content and a plurality of media sources comprising at least one of a web data feed, a wireless broadcast media channel, a web site, and a wired broadcast channel for communication via a personalized video channel;
a data analysis component configured to analyze the video content and corresponding audio content to identify a plurality of topics of the plurality of media sources;
a portioning component configured to portion the video content into portions from the plurality of media sources based on the plurality of topics;
a profile component configured to generate user profile data based on a set of user preferences comprising a topic of the plurality of topics related to the video content; and
a streaming component configured to communicate the video content from the plurality of media sources to a display component based on the user profile data.

2. The system of claim 1, the computer-executable components further comprising:
a video analysis component configured to identify a video transition of the video content of the plurality of media sources based on a set of video criteria.

3. The system of claim 2, wherein the set of video criteria comprises a difference of at least one of a scene setting, one or more actors, a view setting, a first difference threshold of frames being satisfied or a second difference threshold in objects recognized.

4. The system of claim 1, the computer-executable components further comprising:
an audio analysis component configured to identify one or more words or phrases that match the topic and identify an audio transition of the video content based on a set of audio criteria.

5. The system of claim 4, wherein the set of audio criteria comprises at least one of a change in vocal tone, a change in voice, or a change in a frequency of detection with respect to time of the plurality of topics from the video content of the plurality of media sources.

6. The system of claim 1, the computer-executable components further comprising:
a splicing component configured to splice the portions into subsets of the portions of the video content based on an analysis of at least one of a video transition or an audio transition of the video content.

7. The system of claim 1, the computer-executable components further comprising:
a tagging component configured to associate a tag having metadata to the portions respectively of the video content from the plurality of media sources, wherein the metadata comprises at least one of a time of the video content from a corresponding media source of the plurality of media sources, a location comprising a city or region, a device type for compatibility, and a frequency of detection of the topic.

8. The system of claim 1, the computer-executable components further comprising:
an indexing component configured to index the portions of the video content according to a word, or a phrase identified within the audio content of the portions, and associate the portions with a set of classifications.

9. The system of claim 1, the computer-executable components further comprising:
a classification component configured to classify the video content according to a set of classifications based on at least one of a set of themes, a set of media ratings, a set of actors, a set of song artists, a set of album titles, or a set of date ranges.

10. The system of claim 1, the computer-executable components further comprising:
a recommendation component configured to recommend the portions of the video content based on the set of user preferences of the user profile data.

11. The system of claim 1, the computer-executable components further comprising:
a selection component configured to communicate the video content as a set of selections to respectively schedule at a predetermined time in the display component for rendering the video content at the predetermined time.

12. The system of claim 1, wherein the streaming component is further configured to communicate the video content from the plurality of media sources to the display component in response to the set of user preferences of the user profile data designating which of the plurality of media sources that the video content is communicated from via the personalized video channel.

13. The system of claim 1, wherein the set of user preferences comprise at least one of a media source preference, a time preference to associate with the video content, a personalized channel selection, a theme preference, a rating preference, an actor preference, a language preference or a date preference.

14. The system of claim 1, the computer-executable components further comprising:
a chat component configured to generate at least one of audio comments or text comments to the video content based on the user profile data.

15. The system of claim 1, wherein the streaming component is further configured to communicate the video content from different media sources of the plurality of media sources at different times based on the user profile data.

16. The system of claim 1, the computer-executable components further comprising:
a scheduling component configured to generate a schedule of video content from the plurality of media sources via the personalized video channel based on the set of user preferences.

17. The system of claim 1, the computer-executable components further comprising:
a ranking component configured to generate a rank that corresponds to the plurality of topics based on a frequency of detection from the video content of the plurality of media sources.

18. The system of claim 1, wherein the profile component is further configured to generate the user profile data with the set of user preferences and behavioral data.

19. The system of claim 18, wherein the behavioral data comprises at least one of purchased video content, viewed video content, stored video content related, or search criteria for the video content, associated with the user profile data.

20. The system of claim 1, the computer-executable components further comprising:
a splicing component configured to splice the portions into subsets of the portions of the video content based on an analysis of at least one of a video transition or an audio transition of the video content and connect a first portion from a first media source of the plurality of media sources with a second portion from a second media source of the plurality of media sources for viewing via the personalized video channel.

21. A method, comprising:
identifying, by a system comprising at least one processor, a video content from media sources that comprise at least one of a broadcast media channel, a web page, a web data feed, a network subscription service or a video library for communicating the video content via a personalized video channel;
analyzing the video content and audio content of the media sources to determine a plurality of topics based on a set of predetermined criteria;
portioning the video content into portions of the video content corresponding to the plurality of topics; and
streaming the portions from different media sources of the media sources at different times based on a set of user preferences comprising the plurality of topics via the personalized video channel.

22. The method of claim 21, further comprising:
receiving the set of user preferences comprising a set of classification criteria and a topic of the plurality of topics that corresponds to a time of the different times.

23. The method of claim 22, further comprising:
ranking the portions of the video content with a rank based on at least one of a frequency of detection within the audio content associated with the video content, a relevance to a topic of the plurality of topics selected by the user, or reputations or authorities to the user of sources of the portions of the video content.

24. The method of claim 23, further comprising:
scheduling a first portion of the video content based on the rank and a selection of a media source of the media sources to be communicated via the personalized video channel at a first time and a second portion to be communicated via the personalized video channel at a second time.

25. The method of claim 21, further comprising:
analyzing the video content from the media sources to determine a set of video characteristics comprising at least one of bitrate, frame rate, frame size, audio content, formatting, a title, an actor or actress, or metadata pertaining to the video content.

26. The method of claim 25, further comprising:
comparing the video content from the media sources to identify duplicate video content;
removing the duplicate video content from a set of video content selections to be viewed via the personalized video channel; and
maintaining the video content having greater characteristic values of the set of video characteristics than the duplicate video content.

27. The method of claim 21, wherein the portioning the video content into the portions is based on the set of predetermined criteria that comprises a topic of the plurality of topics and at least one of a transition point in the video content, a duration, a match of the set of user preferences or the audio content of the video content being determined to match a word or a phrase of a search criterion of the set of user preferences.

28. The method of claim 21, further comprising:
identifying a video transition of the video content of a media source of the media sources based on a set of video criteria comprising at least one of a difference in a scene setting, a change in one or more characters, a change in view settings, a difference threshold in frames being satisfied or a difference threshold in objects recognized.

29. The method of claim 28, further comprising:
identifying an audio transition of the video content of a the media source of the media sources based on a set of audio criteria comprising at least one of a word or a phrase that matches a topic of the plurality of topics, at least one of a change in vocal tone, a change in voice, or a change in a frequency of detection with respect to time of the plurality of topics from the video content of the media sources.

30. The method of claim 29, further comprising:
partitioning the portions into subsets of the portions of the video content based on the video transition and the audio transition of the video content; and
streaming a first portion from a first media source of the media sources with a second portion from a second media source of the media sources for viewing via the personalized video channel.

31. The method of claim 21, further comprising:
associating a tag having metadata to the portions of the video content respectively from the media sources, wherein the metadata comprises at least one of a time of the video content from a corresponding media source of the media sources, a location comprising a city or region, a device type for compatibility, or a frequency of detection of a topic of the plurality of topics.

32. The method of claim 31, further comprising:
indexing the portions of the video content according to a word or a phrase spoken within the portions, and associating the portions of the video content with a set of classifications.

33. The method of claim 32, further comprising:
classifying the video content according to the set of classifications based on at least one of a set of themes, a set of media ratings, a set of actors, a set of song artists, a set of album titles, or a set of date ranges.

34. The method of claim 33, further comprising:
communicating the portions as a set of selections to respectively schedule at a predetermined time of the different times in a display component for rendering the video content at the predetermined time via the personalized video channel.

35. The method of claim 34, further comprising:
generating at least one of audio comments, text comments or an additional video content with the video content based on the set of user preferences via the personalized video channel.

36. A computer readable storage medium configured to store computer executable instructions that, in response to execution, cause a computing system comprising at least one processor to perform operations, the operations comprising:
identifying a video content from media sources for streaming via a personalized video channel;
analyzing the video content and associated audio content of the video content from the media sources to determine a topic based on a set of predetermined criteria;
portioning the video content into portions corresponding to the topic; and
streaming the portions of the video content from the media sources that comprise the topic via the personalized video channel.

37. The computer readable storage medium of claim 36, the operations further comprising:
associating a tag having metadata to the portions of the video content respectively from the media sources, wherein the metadata comprises at least one of a time of the video content from a corresponding media source of the media sources, a location comprising a city or region, a device type for compatibility, or a rank that satisfies a predetermined rank threshold based on a frequency of detection of the topic.

38. The computer readable storage medium of claim 36, the operations further comprising:
indexing the portions of the video content according to a word or a phrase spoken within the portions.
